(19) United States
(12) Patent Application Publication
(10) Pub. No.: US 2025/0296361 A1
(43) Pub. Date: Sep. 25, 2025

(54) LIQUID EJECTION APPARATUS AND ULTRAVIOLET IRRADIATION APPARATUS

(71) Applicant: SEIKO EPSON CORPORATION, Tokyo (JP)

(72) Inventors: Takuma USUDA, Azumino (JP); Hidekazu KOBAYASHI, Hara-mura (JP)

(21) Appl. No.: 19/087,679

(22) Filed: Mar. 24, 2025

(30) Foreign Application Priority Data
Mar. 25, 2024 (JP) 2024-047839

(51) Int. Cl. B41J 11/00; B41J 25/00; B41J 29/13

(52) U.S. Cl. CPC B41J 11/00218; B41J 11/00214; B41J 25/001; B41J 29/13

(57) ABSTRACT

A liquid ejection apparatus includes a liquid ejection unit configured to eject a liquid that is cured by irradiation with ultraviolet light onto a medium, an irradiation unit configured to irradiate the liquid ejected onto the medium with ultraviolet light, a carriage loaded with the liquid ejection unit and the irradiation unit so as to be arranged side, and configured to move above the medium, and a motor configured to move the carriage, wherein the irradiation unit includes an ultraviolet light source configured to emit the ultraviolet light, a first wall surface located between the ultraviolet light source and the liquid ejection unit, and a second wall surface located at a position at an opposite side to the first wall surface across the ultraviolet light source, and a light absorptance of the second wall surface is higher than a light absorptance of the first wall surface.

The present application is based on, and claims priority from JP Application Serial Number 2024-047839, filed Mar. 25, 2024, the disclosure of which is hereby incorporated by reference herein in its entirety.

### BACKGROUND

### 1. Technical Field

The present disclosure relates to a liquid ejection apparatus and an ultraviolet irradiation apparatus.

### 2. Related Art

There is known a liquid ejection apparatus that ejects ultraviolet-curable ink (an example of a “liquid”) that is cured by irradiation with an ultraviolet light onto a medium. For example, JP-A-2022-017731 discloses a liquid ejection apparatus including a liquid ejection unit that ejects ultraviolet-curable ink onto a medium, an irradiation unit that irradiates a liquid ejected onto the medium with ultraviolet light, a carriage that is loaded with the liquid ejection unit and the irradiation unit and moves along the medium, and a motor that moves the carriage.

JP-A-2022-017731 is an example of the related art.

However, according to the related art, the ultraviolet light emitted from the irradiation unit is reflected by the medium, and the ultraviolet light reflected by the medium may reach the liquid ejection unit in some cases. When the ultraviolet-curable ink adhering to the vicinity of the nozzle for ejecting the ultraviolet-curable ink in the liquid ejection unit is irradiated with the ultraviolet light, the ultraviolet-curable ink adhering to the vicinity of the nozzle is cured, and as a result, an ejection abnormality that it becomes unachievable to normally eject the ultraviolet-curable ink from the liquid ejection unit may occur in some cases.

### SUMMARY

In order to solve the problem described above, a liquid ejection apparatus according to the present disclosure includes a liquid ejection unit configured to eject a liquid that is cured by irradiation with ultraviolet light onto a medium, an irradiation unit configured to irradiate the liquid ejected onto the medium with ultraviolet light, a carriage loaded with the liquid ejection unit and the irradiation unit so as to be arranged side by side in a first direction, and configured to move above the medium in the first direction, and a motor configured to move the carriage, wherein the irradiation unit includes an ultraviolet light source configured to emit the ultraviolet light, a first wall surface located between the ultraviolet light source and the liquid ejection unit, and a second wall surface located at a position at an opposite side to the first wall surface across the ultraviolet light source, and a light absorptance of the second wall surface is higher than a light absorptance of the first wall surface.

Further, an ultraviolet irradiation apparatus according to the present disclosure is an ultraviolet irradiation apparatus provided to a liquid ejection apparatus including a liquid ejection unit configured to eject a liquid that is cured by irradiation with ultraviolet light onto a medium, a carriage loaded with the liquid ejection unit, and configured to move in a first direction above the medium, and a motor configured to move the carriage, and mounted on the carriage so as to be arranged side by side in the first direction with the liquid ejection unit to irradiate the liquid ejected on the medium with ultraviolet light, the ultraviolet irradiation apparatus including an ultraviolet light source configured to emit the ultraviolet light, a first wall surface located between the ultraviolet light source and the liquid ejection unit, and a second wall surface located at a position at an opposite side to the first wall surface across the ultraviolet light source, wherein a light absorptance of the second wall surface is higher than a light absorptance of the first wall surface.

### BRIEF DESCRIPTION OF THE DRAWINGS

FIG. 1 is a block diagram illustrating an example of a configuration of an inkjet printer 1 according to a first embodiment of the present disclosure.

FIG. 2 is a perspective view illustrating an example of a schematic internal structure of the inkjet printer 1.

FIG. 3 is a cross-sectional view illustrating an example of a structure of an ejector D[m].

FIG. 4 is a plan view illustrating an example of an arrangement of loaded objects on a carriage 110.

FIG. 5 is a cross-sectional view illustrating an example of a configuration of an ultraviolet irradiation unit 5.

FIG. 6 is a cross-sectional view illustrating an example of a configuration of an ultraviolet irradiation unit 5 and an ultraviolet light source E.

FIG. 7 is a block diagram illustrating an example of a configuration of a temperature detecting integrated circuit 7.

FIG. 8 is a diagram illustrating an example of a radiant flux characteristic of the ultraviolet light source E.

FIG. 9 is a diagram illustrating a condition assumed in an illuminance simulation.

FIG. 10 is a diagram illustrating a result of a first illuminance simulation.

FIG. 11 is a diagram illustrating an outline of a related-art example.

FIG. 12 is a diagram illustrating thermal conductivity and specific gravity of various types of metal.

FIG. 13 is a cross-sectional view illustrating an example of a configuration of an ultraviolet irradiation unit 5B according to a second embodiment of the present disclosure.

FIG. 14 is a diagram illustrating a condition

assumed in the illuminance simulation.

FIG. 15 is a diagram illustrating a result of a second illuminance simulation.

FIG. 16 is a diagram illustrating a result of third illuminance simulation.

FIG. 17 is a diagram illustrating a result of a fourth illuminance simulation.

FIG. 18 is a diagram illustrating a result of a fifth illuminance simulation.

FIG. 19 is a diagram illustrating a result of a sixth illuminance simulation.

FIG. 20 is a diagram illustrating a result of a seventh illuminance simulation.

FIG. 21 shows the results of an eighth

illuminance simulation.

FIG. 22 is a diagram illustrating the results from the second to eighth illuminance simulations.

FIG. 23 is a cross-sectional view illustrating an example of a configuration of an ultraviolet irradiation unit 5C according to a third embodiment of the present disclosure.

FIG. 24 is a diagram illustrating a condition assumed in the illuminance simulation.

FIG. 25 is a diagram illustrating a result of a ninth illuminance simulation.

FIG. 26 is a diagram illustrating a result of a tenth illuminance simulation.

FIG. 27 is a cross-sectional view illustrating an example of a configuration of an ultraviolet light source E according to Modified Example 1 of the present disclosure.

FIG. 28 is a cross-sectional view illustrating

an example of directional characteristics of the ultraviolet light source E.

### DESCRIPTION OF EMBODIMENTS

Some aspects for implementing the present disclosure will hereinafter be described with reference to the drawings. However, in the drawings, dimensions and scales of the elements are made different from actual ones as appropriate. Further, the following embodiment is preferable specific example of the present disclosure and therefore various technically preferable limitations are imposed thereon, however, the scope of the present disclosure is not limited to the embodiment unless there is a description that the present disclosure is limited thereto in particular in the following description.

### A. First Embodiment

In a first embodiment, a liquid ejection apparatus will be described exemplifying an inkjet printer 1 that ejects ink to form an image on recording paper PP.

### A.1. Overview of Inkjet Printer

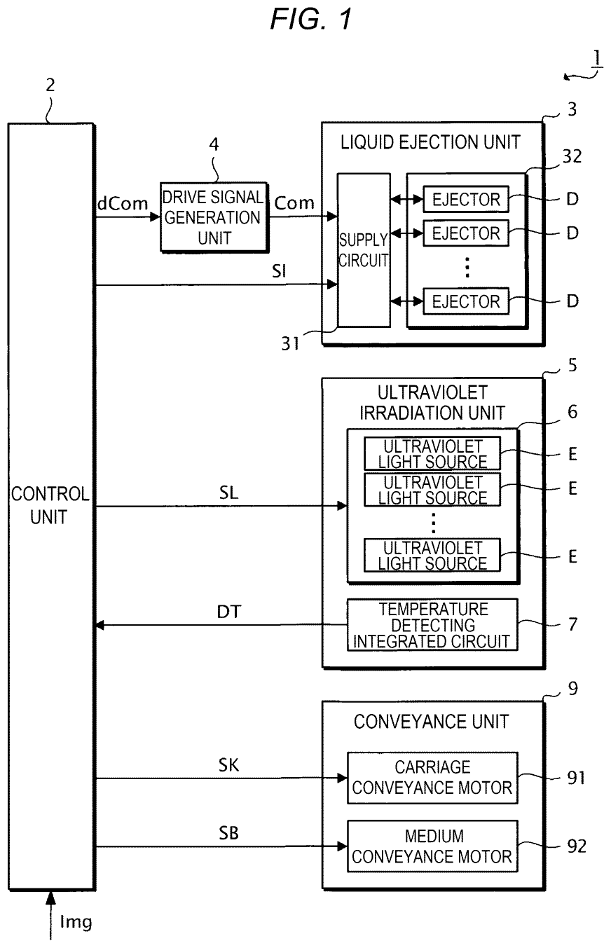

An example of a configuration of an inkjet printer 1 according to the first embodiment will hereinafter be described with reference to FIGS. 1 to 4.

FIG. 1 is a functional block diagram illustrating an example of the configuration of the inkjet printer 1.

As shown in FIG. 1, print data Img representing an image for the inkjet printer 1 to form is supplied to the inkjet printer 1 from a host computer such as a personal computer or a digital camera. The inkjet printer 1 executes print processing of forming the image represented by the print data Img supplied from the host computer on the recording paper PP.

As shown in FIG. 1, the inkjet printer 1 includes a control unit 2 that controls each unit of the inkjet printer 1, a liquid ejection unit 3 provided with ejectors D that eject ink to the recording paper PP, a drive signal generation unit 4 that generates a drive signal Com for driving the ejectors D, an ultraviolet irradiation unit 5 that irradiates the ink ejected on the recording paper PP with ultraviolet light, and a conveyance unit 9 for conveying the liquid ejection unit 3 and the recording paper PP.

Note that in the first embodiment, it is assumed that the ink ejected from the liquid ejection unit 3 is ultraviolet-curable ink that is cured by irradiation with ultraviolet light.

Note that in the first embodiment, the inkjet printer 1 is an example of a “liquid ejection apparatus”, the ultraviolet-curable ink is an example of a “liquid”, the recording paper PP is an example of a “medium”, and the ultraviolet irradiation unit 5 is an example of an “irradiation unit” and an “ultraviolet irradiation apparatus”.

In the first embodiment, it is assumed that the inkjet printer 1 includes a single liquid ejection unit 3 or a plurality of liquid ejection units 3 and a single drive signal generation unit 4 or a plurality of drive signal generation units 4 that correspond one-to-one to the single liquid ejection unit 3 or the plurality of liquid ejection units 3. Specifically, in the first embodiment, it is assumed that the inkjet printer 1 includes four liquid ejection units 3 and four drive signal generation units 4 that correspond one-to-one to the four liquid ejection units 3. However, in the following description, for the sake of convenience of description, as shown in FIG. 1, one of the four liquid ejection units 3 and one of the four drive signal generation units 4 which is provided corresponding to the one of the liquid ejection units 3 may be focused on.

The control unit 2 includes a single central processing unit (CPU) or a plurality of CPUs. However, the control unit 2 may include a programmable logic device such as a field-programmable gate array (FPGA) in place of or in addition to the CPU. Further, the control unit 2 includes a memory. The memory includes either one or both of a volatile memory such as a random access memory (RAM) and a nonvolatile memory such as a read-only memory (ROM), an electrically erasable programmable read-only memory (EEPROM), or a programmable ROM (PROM).

The control unit 2 generates signals for controlling operations of respective units in the inkjet printer 1, such as a designation signal SI, a waveform designation signal dCom, a light source control signal SL, a carriage conveyance control signal SK, and a medium conveyance control signal SB.

Here, the waveform designation signal dCom is a digital signal that defines a waveform of the drive signal Com. The drive signal Com is an analog signal for driving the ejectors D. The designation signal SI is a digital signal for designating a type of an operation of the ejectors D. Specifically, the designation signal SI designates a type of the operation of the ejector D such as whether to eject the ink from the ejector D by designating whether to supply the drive signal Com to the ejector D.

The light source control 1 signal SL is a signal for controlling the ultraviolet irradiation unit 5. The carriage conveyance control signal SK and the medium conveyance control signal SB are signals for controlling the conveyance unit 9.

When print processing is executed, the control unit 2 generates, based on the print data Img, signals for controlling the liquid ejection unit 3, such as the designation signal SI. Further, when the print processing is executed, the control unit 2 generates a signal, such as the waveform designation signal dCom, for controlling the drive signal generation unit 4. Further, when the print processing is executed, the control unit 2 generates signals, such as the carriage conveyance control signal SK and the medium conveyance control signal SB, for controlling the conveyance unit 9. Accordingly, in the print processing, the control unit 2 adjusts whether to eject the ink from the ejector D, ejection timing of the ink, and so on, and controls each unit in the inkjet printer 1 so that an image corresponding to the print data Img is formed on the recording paper PP while controlling the conveyance unit 9 so as to move the liquid ejection unit 3 and the recording paper PP.

As shown in FIG. 1, the liquid ejection unit 3 includes a supply circuit 31 and a liquid ejection head 32.

The liquid ejection head 32 includes M ejectors D. Here, the value M is a natural number satisfying “M≥1”. Note that among the M ejectors D provided to the liquid ejection head 32, an m-th ejector D may hereinafter be referred to as an “ejector D[m]” in some cases. Here, the variable m is a natural number satisfying “1≤m≤M”. Further, when a constituent, a signal, or the like of the inkjet printer 1 corresponds to the ejector D[m] among the M ejectors D, a subscript [m] may hereinafter be added to a reference symbol representing the constituent, the signal, or the like in some cases.

The supply circuit 31 switches whether to supply the drive signal Com to the ejector D[m] based on the designation signal SI. Hereinafter, the drive signal Com which is supplied to the ejector D[m] may be referred to as a supplied drive signal Vin[m] in some cases.

As shown in FIG. 1, the ultraviolet irradiation unit 5 includes an ultraviolet light source module 6 and a temperature detecting integrated circuit 7.

The ultraviolet light source module 6 is provided with a plurality of ultraviolet light sources E for emitting ultraviolet light, and irradiates the recording paper PP conveyed by the conveyance unit 9 with the ultraviolet light.

Note that in the first embodiment, it is assumed that the ultraviolet light emitted by the ultraviolet light source E is ultraviolet light having a wavelength of 250 nm or more and 410 nm or less. Therefore, it is possible to reduce the possibility that the ultraviolet light emitted from the ultraviolet light source E reacts with oxygen in the air to generate ozone, compared to an aspect in which the ultraviolet light having a wavelength 100 nm or more and 230 nm or less is emitted from the ultraviolet light source E.

Further, although not shown in the drawings, the inkjet printer 1 according to the first embodiment is provided with a rubber component (an example of a “specific member”). A rubber component deteriorates when contacting ozone. However, in the first embodiment, as described above, since the ultraviolet light source E emits the ultraviolet light having the wavelength of 250 nm or more and 410 nm or less, it becomes possible to suppress the deterioration of the rubber component compared to when the ultraviolet light source E emits the ultraviolet light having the wavelength 100 nm or more and 230 nm or less.

The temperature detecting integrated circuit 7 detects the temperature in the ultraviolet irradiation unit 5 and outputs a temperature detection signal DT which is a digital signal representing a value based on the temperature thus detected. The control unit 2 generates the light source control signal SL based on the temperature detection signal DT output by the temperature detecting integrated circuit 7.

Note that in the first embodiment, the light source control signal SL is a signal for designating the intensity of the ultraviolet light emitted from the ultraviolet light source E. More specifically, in the first embodiment, the ultraviolet light source module 6 makes the ultraviolet light sources E emit the ultraviolet light based on the intensity represented by the light source control signal SL. However, the present disclosure is not limited to such an aspect. The light source control signal SL may be a signal designating whether to turn ON or OFF the ultraviolet light sources E. In this case, when the light source control signal SL designates ON, the ultraviolet light source module 6 turns ON the ultraviolet light source E and turns OFF the ultraviolet light source E when the light source control signal SL designates OFF.

As shown in FIG. 1, the conveyance unit 9 includes a carriage conveyance motor 91 and a medium conveyance motor 92.

The carriage conveyance motor 91 conveys a carriage 110 described later based on the carriage conveyance control signal SK.

The medium conveyance motor 92 conveys the recording paper PP based on the medium conveyance control signal SB.

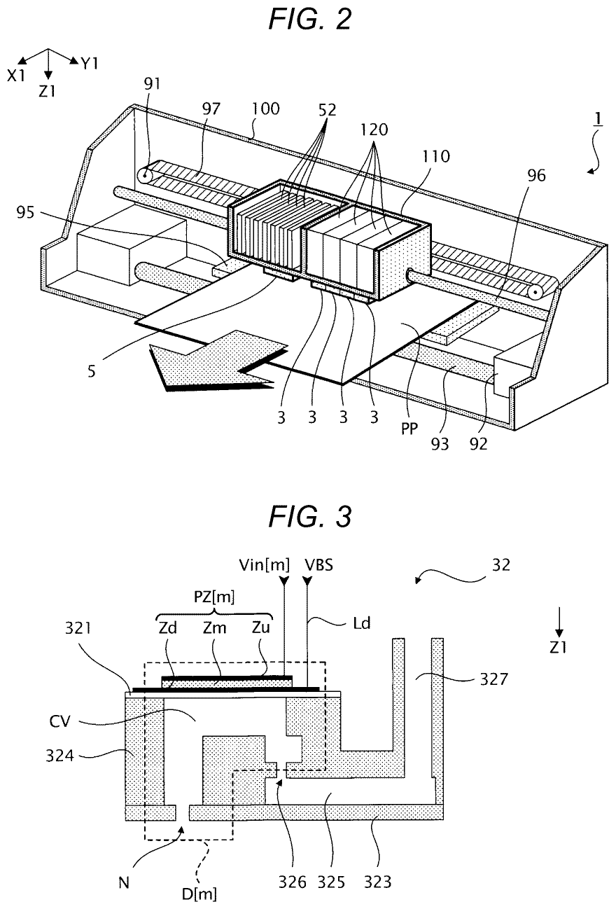

FIG. 2 is a perspective view illustrating an example of a schematic internal structure of the inkjet printer 1.

As shown in FIG. 2, in the first embodiment, it is assumed that the inkjet printer 1 is a serial printer. Specifically, when executing the print processing, the inkjet printer 1 forms an image corresponding to the print data Img on the recording paper PP by ejecting the ink from the liquid ejection unit 3 while conveying the recording paper PP in an X1 direction and moving the liquid ejection unit 3 in a Y1 direction crossing the X1 direction. Further, when the inkjet printer 1 executes the print processing, the inkjet printer 1 cures the ink ejected onto the recording paper PP by irradiating the recording paper PP with the ultraviolet light from the ultraviolet irradiation unit 5 while moving the ultraviolet irradiation unit 5 in the Y1 direction.

Note that in the first embodiment, when the liquid ejection unit 3 is moved up to an end portion in the Y1 direction, the inkjet printer 1 moves the liquid ejection unit 3 in a Y2 direction opposite to the Y1 direction without ejecting the ink from the liquid ejection unit 3. Further, in the first embodiment, the inkjet printer 1 moves the ultraviolet irradiation unit 5 in the Y2 direction without emitting the ultraviolet light from the ultraviolet irradiation unit 5.

Hereinafter, the X1 direction and an X2 direction opposite thereto are collectively referred to as an “X-axis direction”, the Y1 direction crossing the X-axis direction and the Y2 direction opposite to the Y1 direction are collectively referred to as a “Y-axis direction”, and a Z1 direction crossing the X-axis direction and the Y-axis direction and a Z2 direction opposite to the Z1 direction are collectively referred to as a “Z-axis direction”. In the first embodiment, the description will be presented assuming that the X-axis direction, the Y-axis direction, and the Z-axis direction are orthogonal to each another as an example. However, the present disclosure is not limited to such an aspect. It is sufficient for the X-axis direction, the Y-axis direction, and the Z-axis direction to cross each other. Note that in the first embodiment, it is assumed that the Z1 direction is a direction in which the ink is ejected from the ejector D.

As shown in FIG. 2, the inkjet printer 1 according to the first embodiment includes a housing 100 and the carriage 110 capable of reciprocating in the Y-axis direction in the housing 100. The carriage 110 is loaded with the four liquid ejection units 3 and the ultraviolet irradiation unit 5. Specifically, the carriage 110 is loaded with the four liquid ejection units 3 and the ultraviolet irradiation unit 5 such that the four liquid ejection units 3 are located at the Y1 direction side with reference to the ultraviolet irradiation unit 5.

As shown in FIG. 2, in the first embodiment, it is assumed that the carriage 110 is loaded with four ink cartridges 120 that correspond one-to-one to four colors of the ink, that is, cyan, magenta, yellow, and black. Further, in the first embodiment, as described above, it is assumed that the carriage 110 is loaded with the four liquid ejection units 3 that correspond one-to-one to the four ink cartridges 120. Each ejector D[m] is supplied with the ink from the ink cartridge 120 corresponding to the liquid ejection unit 3 provided with that ejector D[m]. Accordingly, each ejector D[m] can be filled with the ink supplied and eject the ink filling the ejector D[m] from a nozzle N provided to the ejector D[m]. Note that the ink cartridges 120 may be disposed outside the carriage 110.

Further, as described above, the inkjet printer 1 according to the first embodiment includes the conveyance unit 9. As shown in FIG. 2, the conveyance unit 9 is provided with the carriage conveyance motor 91 for reciprocating the carriage 110 in the Y-axis direction, a carriage guide shaft 96 for supporting the carriage 110 so as to freely reciprocate in the Y-axis direction, a belt 97 for conveying the carriage 110 in the Y-axis direction based on driving of the carriage conveyance motor 91, the medium conveyance motor 92 for conveying the recording paper PP in the X1 direction, a medium conveyance mechanism 93 for conveying the recording paper PP in the X1 direction by rotating based on driving of the medium conveyance motor 92, and a platen 95 provided at the Z1 direction side of the carriage 110. Therefore, when the print processing is executed, the conveyance unit 9 reciprocates the liquid ejection units 3 together with the carriage 110 in the Y-axis direction along the carriage guide shaft 96 with the carriage conveyance motor 91, and conveys the recording paper PP on the platen 95 in the X1 direction with the medium conveyance motor 92 to thereby change a relative position of the recording paper PP with respect to the liquid ejection units 3 to enable the ink to land on the entire recording paper PP.

Note that in the first embodiment, the carriage conveyance motor 91 is an example of a “motor”.

FIG. 3 is a schematic partial cross-sectional view of the liquid ejection head 32 when the liquid ejection head 32 is cut so as to include the ejector D[m].

As shown in FIG. 3, the ejector D[m] includes a piezoelectric element PZ[m], a cavity CV filled with the ink inside, the nozzle N communicating with the cavity CV, and a vibrating plate 321. The ejector D[m] ejects the ink located inside the cavity CV from the nozzle N by the piezoelectric element PZ[m] being driven by the supplied drive signal Vin[m]. The cavity CV is a space defined by a cavity plate 324, a nozzle plate 323 provided with the nozzle N, and the vibrating plate 321. The cavity CV communicates with a reservoir 325 via an ink supply port 326. The reservoir 325 communicates with the ink cartridge 120 corresponding to the ejector D[m] via an ink intake port 327. The piezoelectric element PZ[m] includes an upper electrode Zu[m], electrode Zd[m], a a lower and piezoelectric body Zm[m] disposed between the upper electrode Zu[m] and the lower electrode Zd[m]. The lower electrode Zd[m] is electrically coupled to a power supply line Ld that is set to a predetermined potential VBS. Further, when the supplied drive signal Vin[m] is supplied to the upper electrode Zu[m] to apply a voltage between the upper electrode Zu[m] and the lower electrode Zd[m], the piezoelectric element PZ[m] is displaced in the Z1 direction or the Z2 direction according to the voltage applied, and as a result, the piezoelectric element PZ[m] vibrates. The lower electrode Zd[m] is bonded to the vibrating plate 321. Therefore, when the piezoelectric element PZ[m] is driven by the supplied drive signal Vin[m] and vibrates, the vibrating plate 321 also vibrates. Further, the volume of the cavity CV and the pressure in the cavity CV change due to the vibration of the vibrating plate 321, and the ink filling the cavity CV is ejected from the nozzle N.

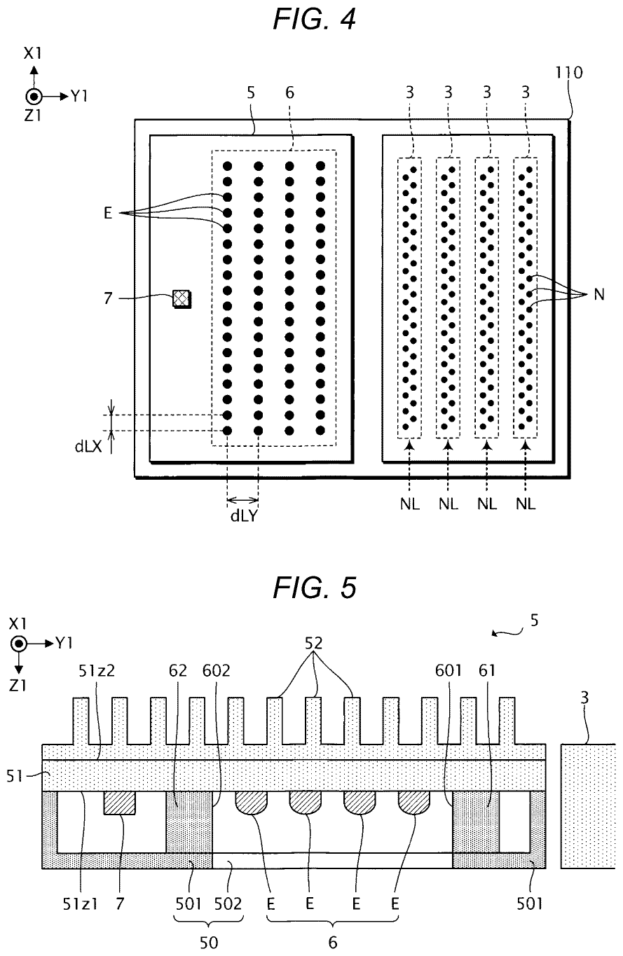

FIG. 4 is a plan view illustrating an example of the arrangement of the loaded objects on the carriage 110 in a plan view of the carriage 110 viewed in the Z2 direction.

As shown in FIG. 4, the carriage 110 is loaded with the ultraviolet irradiation unit 5 and the four liquid ejection units 3 so as to be arranged in the Y1 direction. Specifically, in the first embodiment, it is assumed that the ultraviolet irradiation unit 5 and the four liquid ejection units 3 are mounted on the carriage 110 such that the four liquid ejection units 3 are located at the Y1 direction side with reference to the ultraviolet irradiation unit 5. Therefore, in the first embodiment, when the inkjet printer 1 executes the print processing, immediately after the ink ejected by the liquid ejection unit 3 while moving in the Y1 direction adheres to the recording paper PP, the ultraviolet irradiation unit 5 can irradiate the ink ejected onto the recording paper PP with the ultraviolet light to cure the ink while moving in the Y1 direction.

As shown in FIG. 4, each liquid ejection unit 3 mounted on the carriage 110 is provided with a nozzle column NL. Here, the nozzle column NL is a plurality of nozzles N disposed so as to extend in a column in a predetermined direction. In the first embodiment, it is assumed, as an example, when each of the nozzle columns NL includes M nozzles N arranged so as to extend in the X-axis direction.

As described above, the ultraviolet irradiation unit 5 is provided with the ultraviolet light source module 6 including the plurality of ultraviolet light sources E, and the temperature detecting integrated circuit 7. In the first embodiment it is assumed, as an example, when the ultraviolet light source module 6 is disposed between the temperature detecting integrated circuit 7 and the liquid ejection unit 3 in the carriage 110. However, the present disclosure is not limited to such an aspect. For example, in the carriage 110, the temperature detecting integrated circuit 7 may be disposed between the ultraviolet light source module 6 and the liquid ejection unit 3.

As described above, the ultraviolet light source module 6 includes the plurality of ultraviolet light sources E. In the first embodiment, it is assumed that, in the ultraviolet light source module 6, NX×NY pieces of ultraviolet light sources E are arranged in a matrix of NX rows and NY columns including NX rows in the X1 direction and NY columns in the Y1 direction. Here, the value NX is a natural number satisfying “NX≥1”. Further, the value NY is a natural satisfying “NY≥1”. In the first embodiment, it is assumed that the value NY is “4” as an example.

Further, in the following description, an interval between two ultraviolet light sources E adjacent in the X1 direction to each other among the plurality of ultraviolet light sources E is referred to as an interval dLX, and an interval between two ultraviolet light sources E adjacent in the Y1 direction to each other among the plurality of ultraviolet light sources E is referred to as an interval dLY. In the first embodiment, it is assumed that the interval dLX is equal to or less than the interval dLY as an example. That is, in the first embodiment, it is assumed that an arrangement interval in the X axis direction of the plurality of the ultraviolet light sources E arranged in the matrix is equal to or less than an arrangement interval in the Y-axis direction as an example. Note that the “interval between two ultraviolet light sources E adjacent to each other” may be a distance between the center of one of the two ultraviolet light sources E and the center of the other of the two ultraviolet light sources E in the plan view of the carriage 110 viewed in the Z2 direction, or may be the shortest distance between the one of the two ultraviolet light sources E and the other of the two ultraviolet light sources E.

As shown in FIG. 4, in the first embodiment, it is assumed that the temperature detecting integrated circuit 7 is disposed at an intermediate position in the X-axis direction of the ultraviolet irradiation unit 5. More specifically, in the first embodiment, it is assumed that the temperature detecting integrated circuit 7 is disposed at a position where a distance in the X axis direction from an end portion at the X1 direction side in an arrangement region of the plurality of ultraviolet light sources E in the ultraviolet irradiation unit 5 and a distance in the X-axis direction from an end portion at the X2 direction side in an arrangement region of the plurality of ultraviolet light sources E in the ultraviolet irradiation unit 5 becomes substantially the same. Here, it is assumed that “substantially the same” includes, in addition to the case where two things are completely the same, when the two things can be assumed to be the same in consideration of an error, for example, when two things are the same in design as each other but are different from each other since the two things have manufacturing errors, when two things are the same in specification as each other but different from each other since the two things have errors due to disturbance and so on. In the first embodiment, it is assumed that “substantially the same” is a concept including the case where two things can be assumed to be the same in consideration of an error of about 10%.

### A.2. Overview of Ultraviolet Irradiation Unit 5

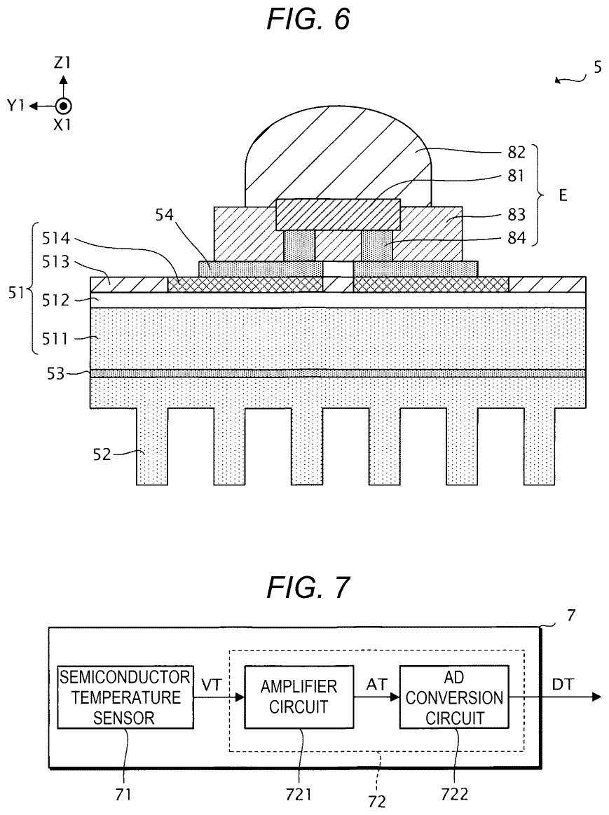

Hereinafter, a configuration of the ultraviolet irradiation unit 5 will be described with reference to FIGS. 5 and 6.

FIG. 5 is a cross-sectional view illustrating an example of a configuration of the ultraviolet irradiation unit 5 when the ultraviolet irradiation unit 5 is cut along a plane having a normal direction parallel to the X-axis direction.

As shown in FIG. 5, the ultraviolet irradiation unit 5 includes a substrate 51, a heatsink 52, and a housing 50 in addition to the ultraviolet light source module 6 including the plurality of ultraviolet light sources E and the temperature detecting integrated circuit 7.

The substrate 51 is a plate-like member extending so as to have a normal direction parallel to the Z-axis direction, and has a surface 51z1 facing to the Z1 direction and a surface 51z2 facing to the Z2 direction as two surfaces having the normal direction parallel to the Z-axis direction.

As shown in FIG. 5, the plurality of ultraviolet light sources E and the temperature detecting integrated circuit 7 are disposed on the surface 51z1. Further, a housing 50 is disposed on the surface 51z1 so as to cover the plurality of ultraviolet light sources E and the temperature detecting integrated circuit 7.

The housing 50 includes a frame 501 that covers the plurality of ultraviolet light sources E and the temperature detecting integrated circuit 7, and a cover plate 502 that is disposed in the Z1 direction with respect to the plurality of ultraviolet light sources E.

The frame 501 is made of metal, and prevents the ink ejected from the liquid ejection units 3 from adhering to electronic components such as the ultraviolet light sources E and the temperature detecting integrated circuit 7 disposed on the substrate 51 and various types of wiring lines disposed on the substrate 51. However, the frame 501 may be a frame formed of a material other than metal such as resin.

The cover plate 502 is formed of glass that transmits the ultraviolet light, and prevents the ink ejected from the liquid ejection units 3 from adhering to the ultraviolet light sources E and various types of wiring lines disposed on the substrate 51. However, the cover plate 502 may be a plate formed of a material other than glass, such as a transparent resin that transmits the ultraviolet light.

Note that in the first embodiment, the cover plate 502 is detachably attached to the frame 501 at will. Specifically, in the first embodiment, it is possible to replace the cover plate 502 with respect to the ultraviolet irradiation unit 5 without detaching the ultraviolet irradiation unit 5 from the inkjet printer 1 while keeping the state in which the ultraviolet irradiation unit 5 is installed in the inkjet printer 1. Therefore, according to the first embodiment, it becomes possible to easily replace the cover plate 502 when, for example, the ink adheres to the cover plate 502 to decrease the intensity of the ultraviolet light applied from the ultraviolet light sources E to the recording paper PP, and thus, it is possible to improve maintainability of the ultraviolet irradiation unit 5 compared to an aspect in which the cover plate 502 is not replaceable.

As shown in FIG. 5, on the surface 51z1, a wall portion 61 is disposed between the plurality of ultraviolet light sources E and the liquid ejection unit 3, and further, a wall portion 62 is disposed between the plurality of ultraviolet light sources E and the temperature detecting integrated circuit 7. Note that in the first embodiment, it is assumed that the wall surface 601 of the wall portion 61, the wall facing the ultraviolet light sources E, and the wall surface 602 of the wall portion 62, the wall surface 602 facing the ultraviolet light sources E, are formed of a low-reflectivity material, such as a black sponge, having an ultraviolet reflectivity of about 0.1% to 10%. In the first embodiment, by forming the wall surfaces 601, 602 from the sponge, mist of the ink is prevented from entering the inside of the cover plate 502 to reduce the possibility that the mist comes into contact with the ultraviolet light sources E. More specifically, in the first embodiment, a silicone sponge made of silicone is adopted as the wall surfaces 601, 602. As a result, the heat resistance of the wall surfaces 601, 602 can be enhanced, and the wall surfaces 601, 602 can be provided with a flame-resistant configuration, and therefore, a configuration suitable for an environment in which the ultraviolet light is applied from the ultraviolet light sources E is achieved. In addition, in the first embodiment, it is assumed that the wall surfaces 601, 602 extend in the Z1 direction in a cross-sectional view of the ultraviolet irradiation unit 5 viewed in the X-axis direction.

As shown in FIG. 5, the heatsink 52 is disposed on the surface 51z2. In the first embodiment, it is assumed that the heatsink 52 is formed of aluminum.

Note that in the first embodiment, the ultraviolet irradiation unit 5 is provided so that a gap with the recording paper PP in the Z-axis direction is no smaller than 1 mm and no larger than 15 mm. Therefore, according to the first embodiment, since the gap between the ultraviolet irradiation unit 5 and the recording paper PP no smaller than 1 mm is ensured, it is possible to reduce the risk that the ultraviolet irradiation unit 5 and the recording paper PP are in contact with each other. In addition, according to the first embodiment, since the gap between the ultraviolet irradiation unit 5 and the recording paper PP is set to be no larger than 15 mm, it is possible to ensure the irradiation intensity with the ultraviolet light applied from the ultraviolet irradiation unit 5 to the recording paper PP.

In addition, in the first embodiment, the plurality of ultraviolet light sources E provided to the ultraviolet irradiation unit 5 are arranged such that an irradiation range on the recording paper PP with the ultraviolet light emitted from one of two ultraviolet light sources E adjacent to each other in the Y-axis direction in the plurality of ultraviolet light sources E and an irradiation range on the recording paper PP with the ultraviolet light emitted from the other of the two ultraviolet light sources E partially overlap each other. Similarly, in the first embodiment, the plurality of ultraviolet light sources E provided to the ultraviolet irradiation unit 5 are arranged such that an irradiation range on the recording paper PP with the ultraviolet light emitted from one of two ultraviolet light sources E adjacent to each other in the X-axis direction in the plurality of ultraviolet light sources E and an irradiation range on the recording paper PP with the ultraviolet light emitted from the other of the two ultraviolet light sources E partially overlap each other.

FIG. 6 is a cross-sectional view illustrating an example of the configuration of the ultraviolet irradiation unit 5 including the ultraviolet light sources E and the substrate 51 when cutting the ultraviolet irradiation unit 5 so as to include the ultraviolet light source E with a plane having a normal direction parallel to the X-axis direction.

As shown in FIG. 6, the ultraviolet light source E includes a light emitting part 81, a lens part 82, a package part 83, and two coupling wiring parts 84. In the first embodiment, it is assumed that a light emitting diode (UV-LED) that emits the ultraviolet light is adopted as the ultraviolet light source E.

The light emitting part 81 is a light emitting functional layer that emits the ultraviolet light. One of the two coupling wiring parts 84 functions as an anode that supplies holes to the light emitting part 81. The other of the two coupling wiring parts 84 functions as a cathode that supplies electrons to the light emitting part 81. Then, by the holes supplied from one of the coupling wiring parts 84 and the electrons supplied from the other of the coupling wiring parts 84 being coupled with each other in the light emitting part 81, the light emitting part 81 emits light, and the ultraviolet light is emitted from the light emitting part 81.

The lens part 82 seals the light emitting part 81 at the Z1 direction side. In the first embodiment, it is assumed that the lens part 82 is formed of a transparent resin that transmits the ultraviolet light. However, the lens part 82 may be formed of silicone. Further, it is preferable that a water-repellent treatment is applied to the lens part 82.

The package part 83 seals the light emitting part 81 at the Y-axis direction side and the X-axis direction side. In the first embodiment, it is assumed that the package part 83 is formed of ceramic. However, the package part 83 may be made of resin.

As shown in FIG. 6, the substrate 51 includes a base member 511, an insulating layer 512, a resist 513, and a plurality of wiring lines 514.

The plurality of wiring lines 514 are formed of a conductive object such as copper, and include one wiring line 514 electrically coupled to one of the coupling wiring parts 84 and another wiring line 514 electrically coupled to the other of the coupling wiring parts 84. Note that in the first embodiment, when the gold plating 54 is disposed between the ultraviolet light source E and the substrate 51 is assumed. Further, in the first embodiment, it is assumed that one of the coupling wiring parts 84 and the one wiring line 514 are electrically coupled via the gold plating 54 and the other of the coupling wiring parts 84 and the other wiring line 514 are electrically coupled via the gold plating 54.

The resist 513 electrically insulates the one wiring line 514 from the other wiring line 514.

The insulating layer 512 electrically insulates the wiring line 514 from the base member 511.

The base member 511 is made of aluminum. In the first embodiment, it is assumed that the heatsink 52 is coupled to the base member 511 with grease 53. However, the heatsink 52 may be coupled to the base member 511 with a heat dissipation sheet.

The heat generated in the light emitting part 81 is released via, for example, the coupling wiring parts 84, the gold plating 54, the wiring lines 514, the insulating layer 512, the base member 511, the grease 53, and the heatsink 52. That is, at least a part of the heat generated in the ultraviolet light source E is released via the base member 511.

Note that in the first embodiment, the area of the base member 511 is larger than the area of the ultraviolet light source module 6 to which the ultraviolet light sources E are provided in the substrate 51 in a plan view of the ultraviolet irradiation unit 5 viewed in the Z1 direction. Therefore, in the first embodiment, it is possible to efficiently release the heat generated in the ultraviolet light source E from the base member 511.

### A.3. Control of Ultraviolet Light Sources E

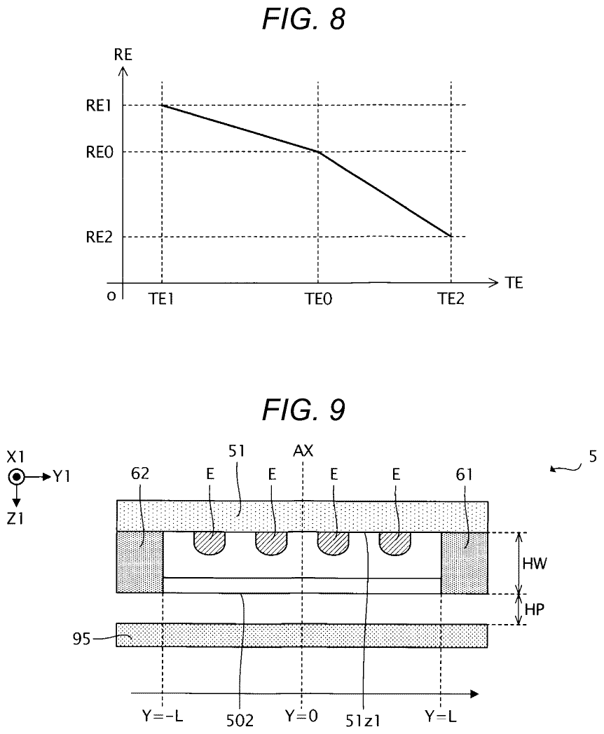

Control of the ultraviolet light sources E based on the temperature detected by the temperature detecting integrated circuit 7 will hereinafter be described with reference to FIGS. 7 and 8.

FIG. 7 is a functional block diagram illustrating an example of a configuration of the temperature detecting integrated circuit 7.

As shown in FIG. 7, the temperature detecting integrated circuit 7 includes a semiconductor temperature sensor 71 and a signal conversion circuit 72.

The semiconductor temperature sensor 71 detects the temperature and then outputs a sensor output signal VT as an analog signal representing the detection result. For example, the semiconductor temperature sensor 71 includes a constant current source and a diode, and outputs, as the sensor output signal VT, a potential difference between both ends of the diode that changes depending on the temperature.

The signal conversion circuit 72 converts the sensor output signal VT as an analog signal into a temperature detection signal DT as a digital signal. For example, the signal conversion circuit 72 includes an amplifier circuit 721 that generates an amplified signal AT obtained by amplifying the sensor output signal VT, and an AD conversion circuit 722 that generates the temperature detection signal DT by converting the amplified signal AT into a digital signal.

Note that in the temperature detecting integrated circuit 7, the semiconductor temperature sensor 71 and the signal conversion circuit 72 are packaged as a single integrated circuit.

FIG. 8 is a diagram illustrating an example of a temperature change in the radiant flux characteristic of the ultraviolet light source E. Specifically, in FIG. 8, the horizontal axis represents the temperature TE of the ultraviolet light source E, and the vertical axis represents the radiant flux RE of the ultraviolet light emitted from the ultraviolet light source E. Here, the radiant flux RE is an energy amount of the ultraviolet light emitted from the ultraviolet light source E per unit time.

As shown in FIG. 8, in the first embodiment, the ultraviolet light source E emits the ultraviolet light with a radiant flux RE0 at a reference temperature TE0, emits the ultraviolet light with a radiant flux RE1 more than the radiant flux RE0 at a temperature TE1 lower than the reference temperature TE0, and emits the ultraviolet light with a radiant flux RE2 less than the radiant flux RE0 at a temperature TE2 higher than the reference temperature TE0. That is, in the first embodiment, the temperature TE of the ultraviolet light source E and the radiant flux RE of the ultraviolet light emitted from the ultraviolet light source E have a negative correlation.

Note that in the first embodiment, the temperature TE1 is an example of a “first temperature”, and the temperature TE2 is an example of a “second temperature”.

In this way, the radiant flux RE of the ultraviolet light emitted from the ultraviolet light source E depends on the temperature of the ultraviolet light source E. That is, the intensity of the ultraviolet light emitted from the ultraviolet light source E depends on the temperature in the ultraviolet irradiation unit 5 in which the ultraviolet light sources E are disposed. Therefore, for example, when the temperature in the ultraviolet light source E is higher than an appropriate temperature, the intensity of the ultraviolet light emitted from the ultraviolet light source E is lower than an appropriate intensity. Accordingly, for example, when the temperature in the ultraviolet light source E is higher than the appropriate temperature, it becomes unachievable to irradiate the recording paper PP with the ultraviolet light having the appropriate intensity from the ultraviolet irradiation unit 5, and the image quality of the image formed on the recording paper PP may be deteriorated in some cases.

In contrast, according to the first embodiment, the control unit 2 generates the light source control signal SL based on the temperature detection signal DT output by the signal conversion circuit 72. Therefore, according to the first embodiment, it becomes possible to irradiate the recording paper PP by the ultraviolet irradiation unit 5 with the ultraviolet light having the intensity according to the temperature in the ultraviolet irradiation unit 5, and it becomes possible to suppress the deterioration of the image quality of an image formed on the recording paper PP.

### A.4. Irradiation Intensity by Ultraviolet Irradiation Unit 5

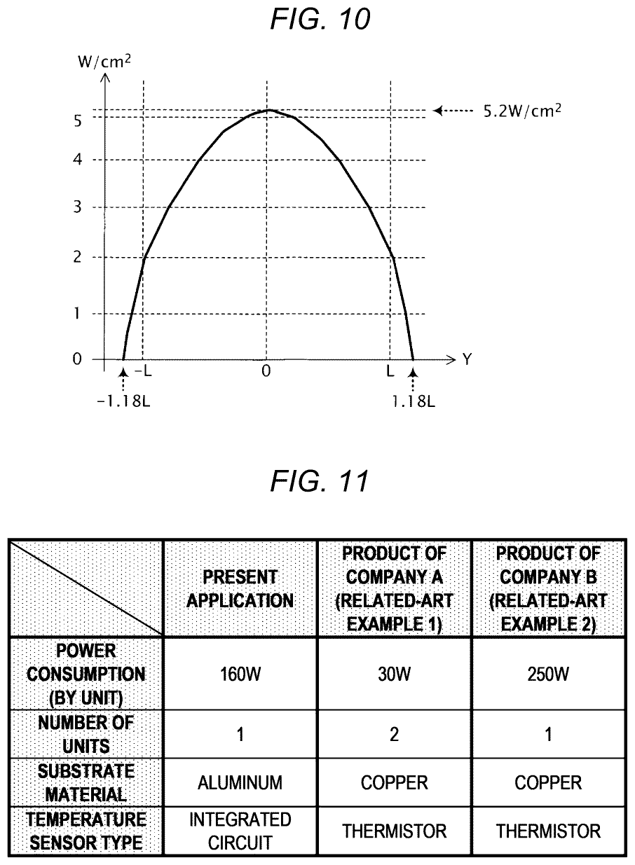

A simulation (hereinafter, referred to as an “illuminance simulation”) related to the intensity (illuminance) of the ultraviolet light applied from the ultraviolet irradiation unit 5 to the recording paper PP will hereinafter be described with reference to FIGS. 9 and 10.

FIG. 9 is a diagram illustrating a condition assumed in the illuminance simulation related to the ultraviolet irradiation from the ultraviolet irradiation unit 5.

As shown in FIG. 9, in the following description, the position in the Y-axis direction of a central axis AX representing a central portion of the ultraviolet light source module 6 is set to “Y=0”, a position in the Y-axis direction of an end portion in the Y1 direction of the cover plate 502 is set to “Y=L”, and a position in the Y-axis direction of an end portion in the Y2 direction of the cover plate 502 is set to “Y=−L”. That is, hereinafter, it is assumed that the width of the cover plate 502 in the Y-axis direction is “2 L”. Here, the value L is a real number that satisfies “L>0”. Further, in the illuminance simulation, “L=12.5 mm”, that is, “2 L=25 mm” is assumed.

Further, the length in the Z-axis direction from the surface 51z1 on which the ultraviolet light sources E are disposed in the substrate 51 to an end portion in the Z1 direction of the cover plate 502 is hereinafter referred to as a unit length HW. Further, in the illuminance simulation, it is assumed that the unit length HW is “8.1 mm”.

Further, the length in the Z-axis direction from an end portion in the Z1 direction of the cover plate 502 to an end portion in the Z2 direction of the platen 95 is hereinafter referred to as a platen gap HP. Further, in the illuminance simulation, it is assumed that the platen gap HP is “1.2 mm”.

Further, in the illuminance simulation, it is assumed that the value NY is “4” and the value NX is “16”. That is, in the illuminance simulation, it is assumed that totally “64” ultraviolet light sources E in a 16×4 matrix are arranged in the ultraviolet light source module 6.

In addition, in the illuminance simulation, it is assumed that the total amount of the ultraviolet light emitted from the 64 ultraviolet light sources E provided to the ultraviolet light source module 6 in one second is “83 W”.

Further, in the illuminance simulation, it is assumed that the interval dLX is “4.4 mm” and the interval dLY is “4.6 mm”.

Further, in the illuminance simulation, it is assumed that the reflectance of the wall surfaces 601, 602 is “5%”, the reflectance of the surface 51z1 is “10%”, and the refractive index of the cover plate 502 is “1.5”.

FIG. 10 is a diagram illustrating a result of the illuminance simulation according to the first embodiment. Specifically, FIG. 10 is a diagram illustrating the illuminance of the ultraviolet light applied to the recording paper PP on a cut surface (hereinafter, referred to as a “target cut surface”) when the recording paper PP disposed at the platen 95 is cut along a plane having a normal direction parallel to the X-axis direction under the conditions of the illuminance simulation illustrated in FIG. 9. Note that the illuminance simulation illustrated in FIG. 9 will hereinafter be referred to as a first illuminance simulation.

As shown in FIG. 10, in the first illuminance simulation, the maximum illuminance in the recording paper PP becomes “5.2 W/cm²”, and the arrival range of the ultraviolet light in the target cut surface is in a range of “−1.18 L” to “1.18 L”. In addition, in the first illuminance simulation, the total value of the illuminance of the ultraviolet light emitted in one second from the ultraviolet irradiation unit 5 is “62 W”.

### A.5. Related-Art Example

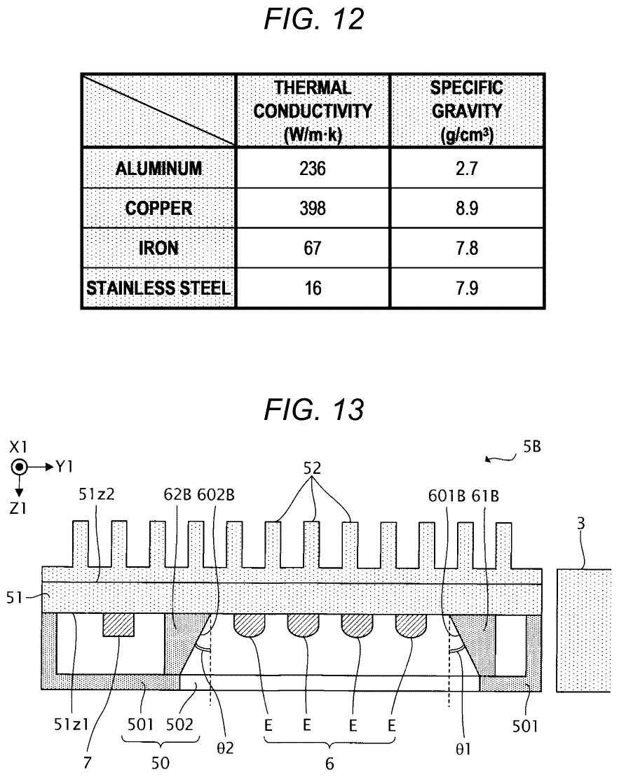

The ultraviolet irradiation unit 5 according to the first embodiment and an ultraviolet irradiation unit according to the related art will hereinafter be described with reference to FIGS. 11 and 12.

FIG. 11 is a diagram illustrating an outline of the ultraviolet irradiation unit 5 according to the first embodiment, an outline of an ultraviolet irradiation unit according to Related-Art Example 1, and an outline of an ultraviolet irradiation unit according to Related-Art Example 2. Note that the ultraviolet irradiation unit according to Related-Art Example 1 is an ultraviolet irradiation unit that is manufactured and sold by another company (company A), and the ultraviolet irradiation unit according to Related-Art Example 2 is an ultraviolet irradiation unit that is manufactured and sold by another company (company B).

As shown in FIG. 11, in the ultraviolet irradiation unit 5 according to the first embodiment, there is provided a single unit having a power consumption of 160 W, and the total power consumption thereof is 160 W. Meanwhile, in the ultraviolet irradiation unit according to Related-Art Example 1, there are provided two units each having a power consumption of 30 W, and the total power consumption is 60 W, and in the ultraviolet irradiation unit according to Related-Art Example 2, there is provided a single unit having a power consumption of 250 W, and the total power consumption is 250 W.

As described above, the ultraviolet irradiation unit 5 according to the first embodiment is large in amount of power consumption similarly to related-art the ultraviolet irradiation unit, and it is important to efficiently release the heat generated in the ultraviolet irradiation unit 5.

As shown in FIG. 11, in the ultraviolet irradiation unit 5 according to the first embodiment, the base member 511 of the substrate 51 provided to the ultraviolet irradiation unit 5 is made of aluminum. That is, the substrate 51 provided to the ultraviolet irradiation unit 5 is a so-called aluminum substrate. In contrast, a base material of the substrate provided to the ultraviolet irradiation unit according to Related-Art Example 1 is formed of copper, and similarly, a base material of the substrate provided to the ultraviolet irradiation unit according to Related-Art Example 2 is also formed of copper. That is, the substrate provided to the ultraviolet irradiation units according to Related-Art Example 1 and Related-Art Example 2 is a so-called copper substrate.

FIG. 12 is a diagram illustrating thermal conductivity and specific gravity of various types of metal.

As shown in FIG. 12, the thermal conductivity of copper is 398 W/mk. Accordingly, the thermal conductivity of copper is high compared to the thermal conductivity of aluminum of 236 W/mk, the thermal conductivity of iron of 67 W/mk, and the thermal conductivity of stainless steel of 16 W/mk. That is, as in the related-art examples, by adopting the copper substrate as the substrate of the ultraviolet irradiation unit, it is possible to efficiently release the heat generated in the ultraviolet irradiation unit. Although silver having a thermal conductivity of 398 W/mk, diamond having a thermal conductivity of 1000 W/mk, and so on also exist as a material higher in thermal conductivity than copper, it is not practical to adopt these materials as the substrate of the ultraviolet irradiation unit since these materials are expensive. For this reason, in the past, a copper substrate has been generally adopted as substrates of ultraviolet irradiation units.

On the other hand, as shown in FIG. 12, the specific gravity of aluminum is 2.7 g/cm³. Accordingly, the specific gravity of aluminum is small compared to the specific gravity of copper of 8.9 g/cm³, the specific gravity of iron of 7.8 g/cm³, and the specific gravity of stainless steel of 7.9 g/cm³. For this reason, in the ultraviolet irradiation unit 5 according to the first embodiment, it becomes possible to reduce the weight of the substrate 51, and by extension, to reduce the weight of the ultraviolet irradiation unit 5, compared to the related-art ultraviolet irradiation units existing in the past such as the ultraviolet irradiation unit according to Related-Art Example 1 and the ultraviolet irradiation unit according to Related-Art Example 2. This makes it possible to reduce the load on the carriage conveyance motor 91 for driving the carriage 110 when the ultraviolet irradiation unit 5 according to the first embodiment is mounted on the carriage 110 to move the ultraviolet irradiation unit 5. That is, in the ultraviolet irradiation unit 5 according to the first embodiment, it becomes possible to extend the life of the carriage conveyance motor 91, and to reduce the amount of electric power for driving the carriage conveyance motor 91 compared to an aspect in which the ultraviolet irradiation unit according to Related-Art Example 1 or the ultraviolet irradiation unit according to Related-Art Example 2 is mounted on the carriage 110.

Further, as described above, the thermal conductivity of aluminum is higher than the thermal conductivity of iron and that of stainless steel although lower than the thermal conductivity of copper. Therefore, according to the ultraviolet irradiation unit 5 according to the first embodiment, it is possible to achieve both a reduction in the load on the carriage conveyance motor 91 for driving the carriage 110 and an efficient heat radiation in the ultraviolet irradiation unit 5.

In addition, it is common that a heatsink is attached to an ultraviolet irradiation unit large in amount of heat generation to improve the heat radiation property in the ultraviolet irradiation unit. Further, the heatsink is generally formed of aluminum. Therefore, when the heatsink made of aluminum is attached to the ultraviolet irradiation unit adopting the copper substrate as in the ultraviolet irradiation unit according to Related-Art Example 1 and the ultraviolet irradiation unit according to Related-Art Example 2, the possibility that corrosion occurs on a boundary between the copper substrate and aluminum becomes high. Accordingly, in the ultraviolet irradiation unit adopting the copper substrate as in the related-art examples, when attaching the heatsink made of aluminum, it is common to interpose a heat dissipation sheet between the copper substrate and the heatsink in order to prevent corrosion on the boundary between the copper substrate and the heatsink made of aluminum. For this reason, in the ultraviolet irradiation unit adopting the copper substrate as in the related-art examples, problems such as an increase in size of the ultraviolet irradiation unit, an increase in cost of the ultraviolet irradiation unit, and an increase in the number of components of the ultraviolet irradiation unit may arise in some cases.

In contrast, the ultraviolet irradiation unit 5 according to the first embodiment adopts, as the substrate 51, an aluminum substrate in which the base member 511 is made of aluminum. Therefore, in the ultraviolet irradiation unit 5 according to the first embodiment, corrosion on the boundary between the base member 511 made of aluminum and the heatsink 52 made of aluminum does not cause a problem. Therefore, in the ultraviolet irradiation unit 5 according to the first embodiment, it is not necessary to interpose the heat dissipation sheet between the substrate 51 and the heatsink 52, and it results in that it is sufficient only to interpose the grease 53 between the substrate 51 and the heatsink 52. According to the above, in the ultraviolet irradiation unit 5 according to the first embodiment, it becomes possible to reduce the size of the ultraviolet irradiation unit 5, to reduce the cost of the ultraviolet irradiation unit 5, and to reduce the number of components of the ultraviolet irradiation unit 5, compared to the ultraviolet irradiation units adopting the copper substrate as in the related-art examples.

It should be noted that aluminum has a production amount subsequent to iron as a base metal, and is considered to exceed iron in proportions to the amount of reserves and the current demand. Further, aluminum is considered to be the metal excellent in recyclability compared to copper. On the other hand, copper has a limited amount of resources, and the state in which the amount of copper used becomes greater than or equal to the present amount of reserves is expected to occur by 2050. In contrast, in the first embodiment, the aluminum substrate having the base member 511 made of aluminum is adopted in the ultraviolet irradiation unit 5. Therefore, according to the first embodiment, it can be said that the environmental burden can be reduced, and the future “copper shortage” is taken into consideration in the aspect compared with the aspect in which the copper substrate is adopted in the ultraviolet irradiation unit 5.

As shown in FIG. 11, the temperature sensor provided to the ultraviolet irradiation unit according to Related-Art Example 1 is a thermistor, and similarly, the temperature sensor provided to the ultraviolet irradiation unit according to Related-Art Example 2 is also a thermistor. As described above, in the past, it has been common in the ultraviolet irradiation unit to adopt the thermistor as a temperature sensor for detecting the temperature of the ultraviolet irradiation unit. However, the thermistor outputs the detected temperature as an analog signal. Accordingly, when the ultraviolet irradiation unit is mounted on the carriage together with the liquid ejection unit, noise caused by various signals for driving the liquid ejection unit is superimposed on the analog signal output from the thermistor, and therefore, there is a possibility that it becomes difficult to accurately figure out the temperature of the ultraviolet irradiation unit.

In contrast, in the ultraviolet irradiation unit 5 according to the first embodiment, an integrated circuit (that is, the temperature detecting integrated circuit 7) is provided as the temperature sensor for detecting the temperature of the ultraviolet irradiation unit 5. Further, in the ultraviolet irradiation unit 5 according to the first embodiment, the temperature detecting integrated circuit 7 outputs the temperature detection signal DT which is a digital signal indicating the detection result of the temperature of the ultraviolet irradiation unit 5. Therefore, according to the first embodiment, it is possible to prevent the temperature detection signal DT output from the temperature detecting integrated circuit 7 from being affected by various signals such as the drive signal Com that drives the liquid ejection units 3 even when the ultraviolet irradiation unit 5 is mounted on the carriage 110 together with the liquid ejection units 3. That is, according to the first embodiment, it is possible to accurately figure out the temperature of the ultraviolet irradiation unit 5 compared to the related-art examples in which the thermistor is adopted as the temperature sensor.

### B. Second Embodiment

An inkjet printer according to a second embodiment will hereinafter be described with reference to FIGS. 13 to 22. Note that in the aspects hereinafter exemplified, regarding the elements having similarly the same operations and functions as in the first embodiment, the reference numerals and signs used in the description of the first embodiment are diverted thereto to thereby omit the detailed description thereof as appropriate.

FIG. 13 is a cross-sectional view illustrating an example of a configuration of an ultraviolet irradiation unit 5B when cutting the ultraviolet irradiation unit 5B provided to the inkjet printer according to the second embodiment with a plane having the normal direction parallel to the X-axis direction. Note that the inkjet printer according to the second embodiment has similarly the same configuration as that of the inkjet printer 1 according to the first embodiment except that the inkjet printer according to the second embodiment includes the ultraviolet irradiation unit 5B instead of the ultraviolet irradiation unit 5.

As shown in FIG. 13, the ultraviolet irradiation unit 5B has similarly the same configuration as that of the ultraviolet irradiation unit 5 according to the first embodiment except that a wall portion 61B is provided instead of the wall portion 61 and a wall portion 62B is provided instead of the wall portion 62.

The wall portion 61B includes a wall surface 601B facing the ultraviolet light source E.

The wall surface 601B extends in a direction between the Z1 direction and the Y1 direction and in a direction forming an angle θ1 with the Z1 direction in a cross-sectional view of the ultraviolet irradiation unit 5B viewed in the X-axis direction. Here, the angle θ1 is an angle no smaller than 0 degree and no larger than 30 degrees, preferably an angle no smaller than 5 degrees and no larger than 15 degrees, and more preferably an angle no smaller than 5 degrees and no larger than 10 degrees. Further, the wall surface 601B is a reflective surface having a reflectance no lower than 70%, preferably a reflective surface having a reflectance no lower than 85%, and more preferably a reflective surface having a reflectance no lower than 90%.

The wall portion 62B includes a wall surface 602B facing the ultraviolet light source E.

The wall surface 602B extends in a direction between the Z1 direction and the Y2 direction and in a direction forming an angle θ2 with the Z1 direction in a cross-sectional view of the ultraviolet irradiation unit 5B viewed in the X-axis direction. Here, the angle θ2 is an angle no smaller than 0 degree and no larger than 30 degrees, preferably an angle no smaller than 5 degrees and no larger than 15 degrees, and more preferably an angle no smaller than 5 degrees and no larger than 10 degrees. Further, the wall surface 602B is a reflective surface having a reflectance no lower than 70%, preferably a reflective surface having a reflectance no lower than 85%, and more preferably a reflective surface having a reflectance no lower than 90%.

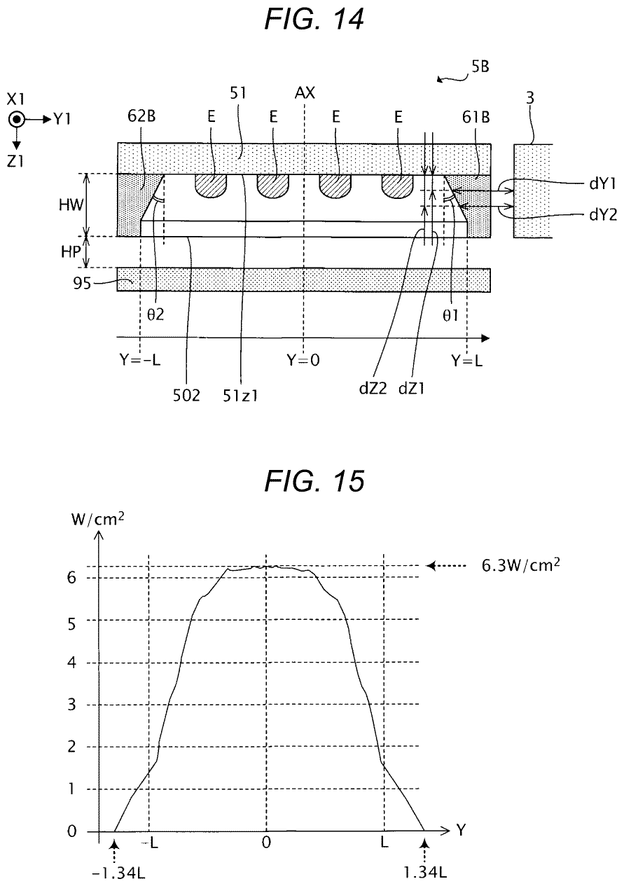

FIG. 14 is a diagram illustrating a condition assumed in the illuminance simulation related to the ultraviolet irradiation from the ultraviolet irradiation unit 5B.

As shown in FIG. 14, in the illuminance simulation in the second embodiment, similarly to the first embodiment, it is assumed that a position in the Y-axis direction of an end portion in the Y1 direction of the cover plate 502 is “Y=L”, a position in the Y-axis direction of an end portion in the Y2 direction of the cover plate 502 is “Y=−L”, and the width of the cover plate 502 in the Y-axis direction is “2 L=25 mm”. Further, in the illuminance simulation in the second embodiment, similarly to the first embodiment, it is assumed that the unit length HW is “8.1 mm” and the platen gap HP is “1.2 mm”. Further, in the illuminance simulation in the second embodiment, similarly to the first embodiment, it is assumed that NY columns are “4”, NX rows are “16”, the interval dLX is “4.4 mm”, and the interval dLY is “4.6 mm” is assumed. In addition, in the illuminance simulation in the second embodiment, similarly to the first embodiment, it is assumed that the total amount of the ultraviolet light emitted from the 64 ultraviolet light sources E provided to the ultraviolet light source module 6 in one second is “83 W”. Further, in the illuminance simulation in the second embodiment, similarly to the first embodiment, it is assumed that the reflectance of the surface is “10%”, and the refractive index of the cover plate 502 is “1.5”.

Further, in the illuminance simulation in the second embodiment, it is assumed that the reflectance of the wall surfaces 601B, 602B is “90%”.

Note that as described above, the wall surface 601B extends in the direction between the Z1 direction and the Y1 direction and in the direction forming the angle θ1 with the Z1 direction in the cross-sectional view of the ultraviolet irradiation unit 5B viewed in the X-axis direction. Therefore, as shown in FIG. 14, the distance dY1 in the Y1 direction between the wall surface 601B and the liquid ejection unit 3 when the distance in the Z1 direction from the substrate 51 is the distance dZ1 (an example of the “first distance”) is equal to or longer than the distance dY2 in the Y1 direction between the wall surface 601B and the liquid ejection unit 3 when a distance in the Z1 direction from the substrate 51 is longer than the distance dZ2 (an example of the “second distance”) longer than the distance dZ1. However, when the angle θ1 is “θ1>0”, the distance dY1 is longer than the distance dY2.

FIG. 15 is a diagram illustrating a result of the illuminance simulation (hereinafter, referred to as a “second illuminance simulation”) related to the illuminance of the ultraviolet light applied from the ultraviolet irradiation unit 5B to the recording paper PP on the target cut surface when the angle θ1 is set to “0 degree” and the angle θ2 is set to “0 degree” in FIG. 14.

As shown in FIG. 15, in the second illuminance simulation, the maximum illuminance in the recording paper PP becomes “6.3 W/cm²”, and the arrival range of the ultraviolet light in the target cut surface is in a range of “−1.34 L” to “1.34 L”. Further, in the second illuminance simulation, the total value of the illuminance of the ultraviolet light emitted in one second from the ultraviolet irradiation unit 5B is “75 W”.

FIG. 16 is a diagram illustrating a result of the illuminance simulation (hereinafter, referred to as a “third illuminance simulation”) related to the illuminance of the ultraviolet light applied from the ultraviolet irradiation unit 5B to the recording paper PP on the target cut surface when the angle θ1 is set to “5 degrees” and the angle θ2 is set to “5 degrees” in FIG. 14.

As shown in FIG. 16, in the third illuminance simulation, the maximum illuminance in the recording paper PP becomes “6.0 W/cm²”, and the arrival range of the ultraviolet light in the target cut surface is in a range of “−1.08 L” to “1.08 L”. In addition, in the third illuminance simulation, the total value of the illuminance of the ultraviolet light emitted in one second from the ultraviolet irradiation unit 5B is “76 W”.

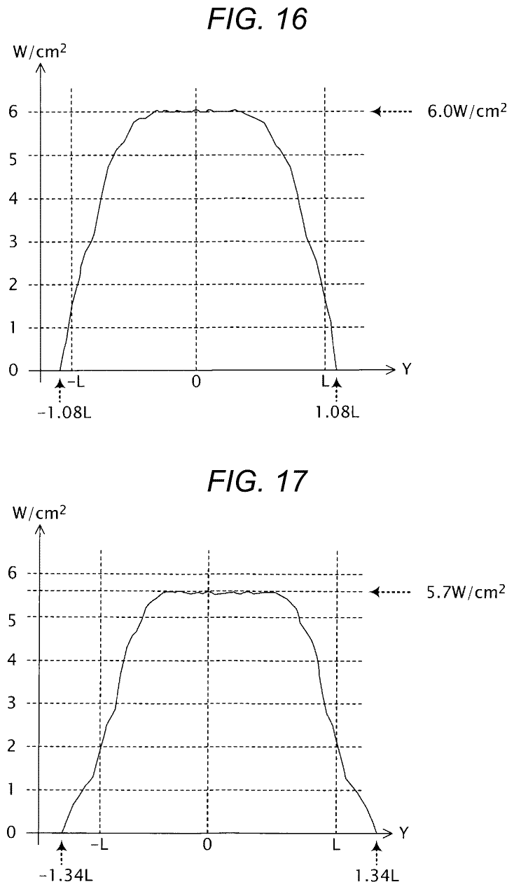

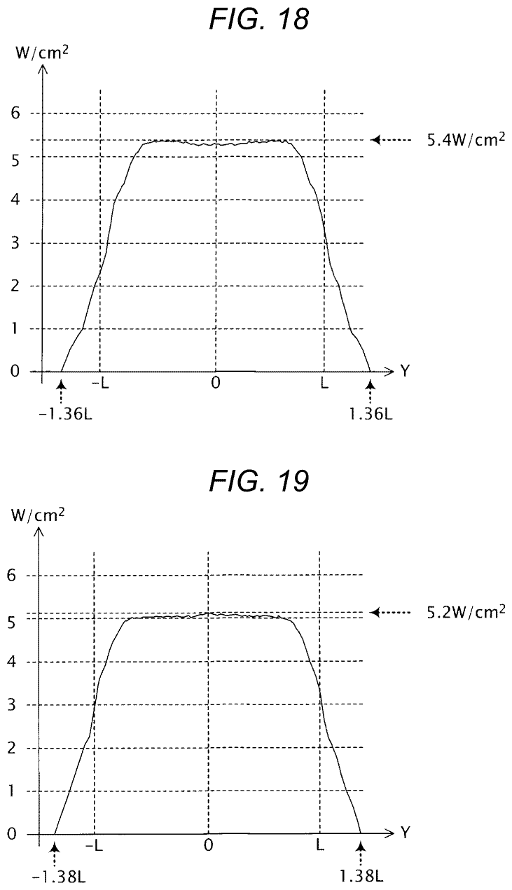

FIG. 17 is a diagram illustrating a result of the illuminance simulation (hereinafter, referred to as a “fourth illuminance simulation”) related to the illuminance of the ultraviolet light applied from the ultraviolet irradiation unit 5B to the recording paper PP on the target cut surface when the angle θ1 is set to “10 degrees” and the angle θ2 is set to “10 degrees” in FIG. 14.

As shown in FIG. 17, in the fourth illuminance simulation, the maximum illuminance in the recording paper PP becomes “5.7 W/cm²”, and the arrival range of the ultraviolet light in the target cut surface is in a range of “−1.34 L” to “1.34 L”. In addition, in the fourth illuminance simulation, the total value of the illuminance of the ultraviolet light emitted in one second from the ultraviolet irradiation unit 5B is “77 W”.

FIG. 18 is a diagram illustrating a result of the illuminance simulation (hereinafter, referred to as a “fifth illuminance simulation”) related to the illuminance of the ultraviolet light applied from the ultraviolet irradiation unit 5B to the recording paper PP on the target cut surface when the angle θ1 is set to “15 degrees” and the angle θ2 is set to “15 degrees” in FIG. 14.

As shown in FIG. 18, in the fifth illuminance simulation, the maximum illuminance in the recording paper PP becomes “5.4 W/cm²”, and the arrival range of the ultraviolet light in the target cut surface is in a range of “−1.36 L” to “1.36 L”. In addition, in the fifth illuminance simulation, the total value of the illuminance of the ultraviolet light emitted in one second from the ultraviolet irradiation unit 5B is “77 W”.

FIG. 19 is a diagram illustrating a result of the illuminance simulation (hereinafter, referred to as a “sixth illuminance simulation”) related to the illuminance of the ultraviolet light applied from the ultraviolet irradiation unit 5B to the recording paper PP on the target cut surface when the angle θ1 is set to “20 degrees” and the angle θ2 is set to “20 degrees” in FIG. 14.

As shown in FIG. 19, in the sixth illuminance simulation, the maximum illuminance in the recording paper PP becomes “5.2 W/cm²”, and the arrival range of the ultraviolet light in the target cut surface is in a range of “−1.38 L” to “1.38 L”. Further, in the sixth illuminance simulation, the total value of the illuminance of the ultraviolet light emitted in one second from the ultraviolet irradiation unit 5B is “77 W”.

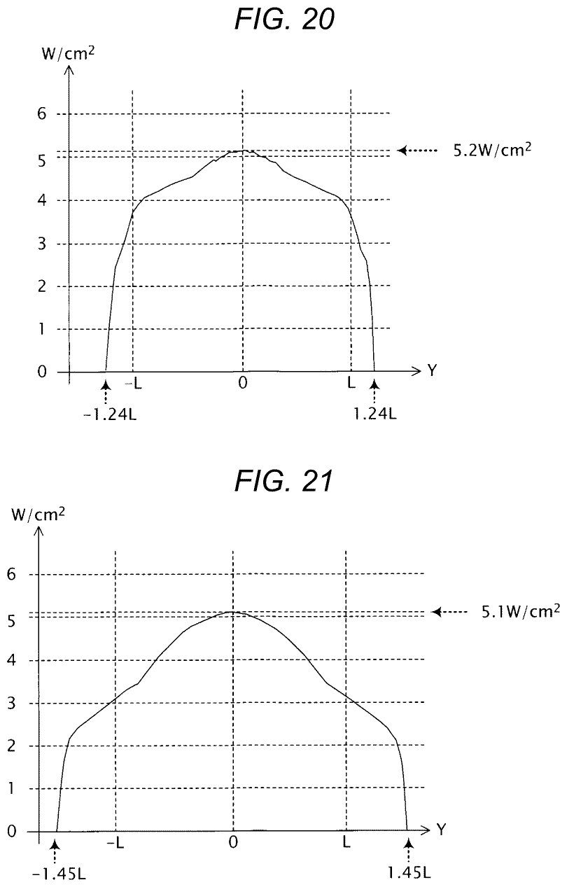

FIG. 20 is a diagram illustrating a result of the illuminance simulation (hereinafter, referred to as a “seventh illuminance simulation”) related to the illuminance of the ultraviolet light applied from the ultraviolet irradiation unit 5B to the recording paper PP on the target cut surface when the angle θ1 is set to “30 degrees” and the angle θ2 is set to “30 degrees” in FIG. 14.

As shown in FIG. 20, in the seventh illuminance simulation, the maximum illuminance in the recording paper PP becomes “5.2 W/cm²”, and the arrival range of the ultraviolet light in the target cut surface is in a range of “−1.24 L” to “1.24 L”. Further, in the seventh illuminance simulation, the total value of the illuminance of the ultraviolet light emitted in one second from the ultraviolet irradiation unit 5B is “76 W”.

FIG. 21 is a diagram illustrating a result of the illuminance simulation (hereinafter, referred to as an “eighth illuminance simulation”) related to the illuminance of the ultraviolet light applied from the ultraviolet irradiation unit 5B to the recording paper PP on the target cut surface when the angle θ1 is set to “45 degrees” and the angle θ2 is set to “45 degrees” in FIG. 14.

As shown in FIG. 21, in the eighth illuminance simulation, the maximum illuminance in the recording paper PP becomes “5.1 W/cm²”, and the arrival range of the ultraviolet light in the target cut surface is in a range of “−1.45 L” to “1.45 L”. Further, in the eighth illuminance simulation, the total value of the illuminance of the ultraviolet light emitted in one second from the ultraviolet irradiation unit 5B is “76 W”.

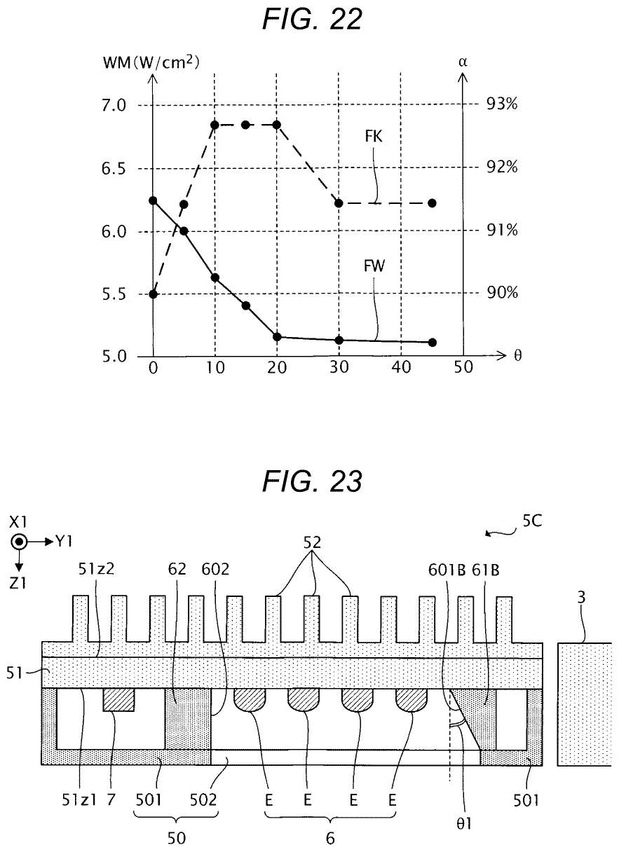

FIG. 22 is a diagram illustrating the results

from the second illuminance simulation to the eighth illuminance simulation illustrated in FIGS. 15 to 21. Note that in FIG. 22, the solid line FW represents a maximum illuminance WM in each illuminance simulation, and the broken line FK represents an irradiation efficiency α in each illuminance simulation. Here, the irradiation efficiency α is a value obtained by dividing, in each illuminance simulation, the total value of the illuminance irradiated in one second from the ultraviolet irradiation unit 5B to the recording paper PP by the total amount of the ultraviolet light emitted per second from the 64 ultraviolet light sources E provided in the ultraviolet light source module 6. Further, in FIG. 22, “θ1=θ2=0” is assumed.

As represented by the solid line FW in FIG. 22, the maximum illuminance WM increases as the angle θ decreases. Therefore, in order to more surely cure the ink by the ultraviolet irradiation, it is preferable to increase the maximum illuminance WM by reducing the angle ∂. Therefore, from the viewpoint of the reliability of curing the ink, for example, the angle e is preferably in a range of “no smaller than 0 degree and no larger than 15 degrees”, and more preferably in a range of “no smaller than 0 degree and no larger than 10 degrees”.

On the other hand, in order to increase the irradiation efficiency α of the ultraviolet light from the ultraviolet irradiation unit 5B, the angle θ is preferably in a range of “no smaller than 5 degrees and no larger than 45 degrees”.

In contrast, in the second embodiment, the angle e is set to be “no smaller than 0 degree and no larger than 30 degrees”, preferably “no smaller than 5 degrees and no larger than 15 degrees”, and more preferably “no smaller than 5 degrees and no larger than 10 degrees”. Therefore, according to the second embodiment, it is possible to achieve both an improvement of the reliability of the curing of the ink by increasing the maximum illuminance WM, and a reduction of the power related to the drive of the ultraviolet irradiation unit 5B by increasing the irradiation efficiency.

### C. Third Embodiment

An inkjet printer according to a third embodiment will hereinafter be described with reference to FIGS. 23 to 26. Note that in the aspects hereinafter exemplified, regarding the elements having similarly the same operations and functions as in the first embodiment or the second embodiment, the reference numerals and signs used in the description of the first embodiment or the second embodiment are diverted thereto to thereby omit the detailed description thereof as appropriate.

FIG. 23 is a cross-sectional view illustrating an example of a configuration of an ultraviolet irradiation unit 5C when cutting the ultraviolet irradiation unit 5C provided to the inkjet printer according to the third embodiment with a plane having the normal direction parallel to the X-axis direction. Note that the inkjet printer according to the third embodiment has similarly the same configuration as that of the inkjet printer 1 according to the first embodiment except that the inkjet printer according to the second embodiment includes the ultraviolet irradiation unit 5C instead of the ultraviolet irradiation unit 5.

As shown in FIG. 23, the ultraviolet irradiation unit 5C has similarly the same configuration as that of the ultraviolet irradiation unit 5 according to the first embodiment except that a wall portion 61B is provided instead of the wall portion 61. That is, the ultraviolet irradiation unit 5C includes the wall portion 61B having the wall surface 601B having a reflectance of 70% or more between the ultraviolet light source E and the liquid ejection unit 3, and a wall portion 62 having a wall surface 602 having a reflectance of about 0.1% to 10% at an opposite side to the liquid ejection unit 3 when viewed from the ultraviolet light source E. In other words, in the ultraviolet irradiation unit 5C, the light absorptance of the wall surface 602 of the wall portion 62 disposed at the side opposite to the liquid ejection unit 3 when viewed from the ultraviolet light source E is higher than the light absorptance of the wall surface 601B of the wall portion 61B disposed between the ultraviolet light source E and the liquid ejection unit 3. In addition, in the third embodiment, similarly to the first embodiment or the second embodiment, it is assumed that the wall surface 601B extends in a direction between the Z1 direction and the Y1 direction and in a direction forming an angle θ1 with the Z1 direction, and the wall surface 602 extends in the Z1 direction in a cross-sectional view of the ultraviolet irradiation unit 5C viewed in the X-axis direction.

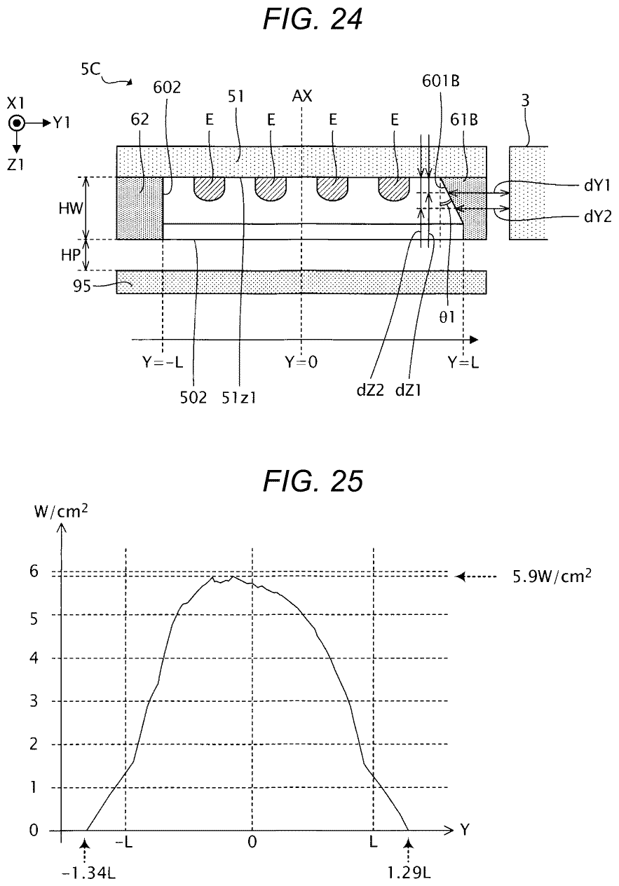

FIG. 24 is a diagram illustrating a condition assumed in the illuminance simulation related to the ultraviolet irradiation from the ultraviolet irradiation unit 5C.

As shown in FIG. 24, in the illuminance simulation in the third embodiment, similarly to the first embodiment, it is assumed that a position in the Y-axis direction of an end portion in the Y1 direction of the cover plate 502 is “Y=L”, a position in the Y-axis direction of an end portion in the Y2 direction of the cover plate 502 is “Y=−L”, and the width of the cover plate 502 in the Y-axis direction is “2 L=25 mm”. Further, in the illuminance simulation in the third embodiment, similarly to the first embodiment, it is assumed that the unit length HW is “8.1 mm” and the platen gap HP is “1.2 mm”. Further, in the illuminance simulation in the third embodiment, similarly to the first embodiment, it is assumed that NY columns are “4”, NX rows are “16”, the interval dLX is “4.4 mm”, and the interval dLY is “4.6 mm” is assumed. In addition, in the illuminance simulation in the third embodiment, similarly to the first embodiment, it is assumed that the total amount of the ultraviolet light emitted from the 64 ultraviolet light sources E provided to the ultraviolet light source module 6 in one second is “83 W”. Further, in the illuminance simulation in the third embodiment, similarly to the first embodiment and the second embodiment, it is assumed that the reflectance of the surface 51z1 is “10%”, the reflectance of the wall surface 601B is “90%”, the reflectance of the wall surface 602 is “5%”, and the refractive index of the cover plate 502 is “1.5”.

FIG. 25 is a diagram illustrating a result of the illuminance simulation (hereinafter, referred to as a “ninth illuminance simulation”) related to the illuminance of the ultraviolet light applied from the ultraviolet irradiation unit 5C to the recording paper PP on the target cut surface when the angle θ1 is set to “0 degree” in FIG. 24.

As shown in FIG. 25, in the ninth illuminance simulation, the maximum illuminance in the recording paper PP becomes “5.9 W/cm²”, and the arrival range of the ultraviolet light in the target cut surface is in a range of “−1.34 L” to “1.29 L”. Further, in the ninth illuminance simulation, the total value of the illuminance of the ultraviolet light emitted in one second from the ultraviolet irradiation unit 5C is “68 W”. Further, in the ninth illuminance simulation, the illuminance in a region satisfying “Y>0” is lower than the illuminance in a region satisfying “Y<0”. In other words, in the ninth illuminance simulation, the illuminance in the region closer to the liquid ejection unit 3 than the central axis AX is lower than the illuminance in the region farther from the liquid ejection unit 3 than the central axis AX.

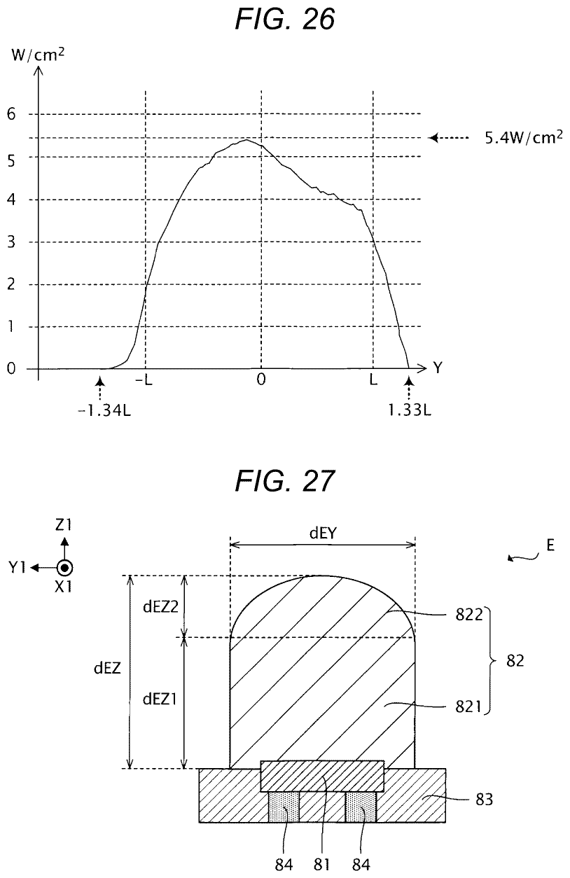

FIG. 26 is a diagram illustrating a result of the illuminance simulation (hereinafter, referred to as a “tenth illuminance simulation”) related to the illuminance of the ultraviolet light applied from the ultraviolet irradiation unit 5C to the recording paper PP on the target cut surface when the angle θ1 is set to “30 degrees” in FIG. 24.

As shown in FIG. 26, in the tenth illuminance simulation, the maximum illuminance in the recording paper PP becomes “5.4 W/cm²”, and the arrival range of the ultraviolet light in the target cut surface is in a range of “−1.34 L” to “1.33 L”. Further, in the tenth illuminance simulation, the total value of the illuminance of the ultraviolet light emitted in one second from the ultraviolet irradiation unit 5C is “70 W”. Further, in the tenth illuminance simulation, the illuminance in a region satisfying “Y>0” is lower than the illuminance in a region satisfying “Y<0”. In other words, in the tenth illuminance simulation, the illuminance in the region closer to the liquid ejection unit 3 than the central axis AX is lower than the illuminance in the region farther from the liquid ejection unit 3 than the central axis AX.

As described above, according to the third embodiment, since the reflectance of the wall surface 602 is lower than the reflectance of the wall surface 601B, it is possible to make the illuminance of the ultraviolet light emitted toward the Y1 direction from the ultraviolet irradiation unit 5C lower than the illuminance of the ultraviolet light emitted toward the Y2 direction from the ultraviolet irradiation unit 5C. For this reason, according to the third embodiment, it is possible to reduce the amount of the ultraviolet light that is emitted from the ultraviolet irradiation unit 5C, and then reflected by the recording paper PP to reach the liquid ejection unit 3 compared to the second embodiment described above. That is, according to the third embodiment, it is possible to reduce the possibility of occurrence of the ejection abnormality of the ejector D due to the irradiation of the liquid ejection unit 3 with the ultraviolet light compared to the second embodiment described above.

### D. Modified Examples

The aspects described hereinabove can variously be modified. Specific aspects of the modified examples will be exemplified below. Two or more aspects randomly selected from the following exemplifications can be combined as appropriate within a range where the aspects are mutually consistent. Note that in the modified examples exemplified below, elements having equivalent actions and functions to those of the embodiments are denoted by the signs referred to in the above description to omit the detailed description thereof as appropriate.

### D.1. Modified Example 1

In the first to third embodiments described above, the lens part 82 provided to the ultraviolet light source E may be characterized in that the height dEZ in the Z-axis direction of the lens part 82 is longer than the width dEY in the Y-axis direction of the lens part 82, and is longer than the width dEX (not shown) in the X-axis direction of the lens part 82.

FIG. 27 is a cross-sectional view illustrating an example of the configuration of the ultraviolet light source E when the ultraviolet light source E according to Modified Example 1 is cut with a plane having a normal direction parallel to the X-axis direction.

As shown in FIG. 27, the ultraviolet light source E according to Modified Example 1 includes the light emitting part 81, the lens part 82, the package part 83, and coupling wiring parts 84, similarly to the ultraviolet light source E according to the embodiments. In Modified Example 1, the lens part 82 includes a base portion 821 having a columnar shape and a tip portion 822 having a hemispherical shape.

The base portion 821 has a height dEZ1 in the Z-axis direction, and has a width dEY in the X-axis direction and the Y-axis direction. That is, the base portion 821 has a circular shape having a diameter dEY when viewed from the Z-axis direction.

The tip portion 822 is coupled to the base portion 821 at the Z1 direction side with reference to the base portion 821, and has a height dEZ2 in the Z-axis direction, and the width dEY in the X-axis direction and the Y-axis direction. That is, the tip portion 822 has a circular shape having a diameter dEY when viewed from the Z-axis direction.

In the present modified example, the lens part 82 has a shape in which the height dEZ1, the height dEZ2, and the width dEY satisfy “dEZ1+dEZ2=dEZ>dEY”. That is, in the present modified example, the lens part 82 has a shape in which the length of the lens part 82 in the Z-axis direction is longer than the diameter of the base portion 821.

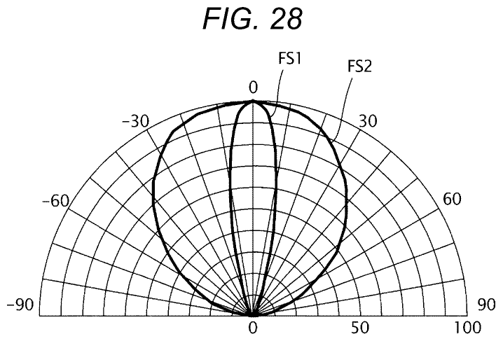

FIG. 28 is a diagram illustrating an example of the directional characteristics of the ultraviolet light source E in the present modified example and the directional characteristics of the ultraviolet light source in a comparative example. Note that the ultraviolet light source in the comparative example has substantially the same configuration as that of the ultraviolet light source E according to Modified Example 1 except that the ultraviolet light source in the comparative example has a shape in which the length in the Z-axis direction of the lens part 82 is shorter than the diameter of the base portion 821.

As shown in FIG. 28, the ultraviolet light source E according to Modified Example 1 has a high directivity as represented by the curve FS1. On the other hand, as represented by the curve FS2, the ultraviolet light source in the comparative example is low in directivity. For this reason, by adopting the ultraviolet light source E according to Modified Example 1 as the ultraviolet light source E used in the ultraviolet irradiation unit 5 (or the ultraviolet irradiation unit 5B or the ultraviolet irradiation unit 5C), it is possible to improve the irradiation efficiency of the ultraviolet light from the ultraviolet irradiation unit 5 and to reduce the possibility that the ultraviolet light emitted from the ultraviolet irradiation unit 5 is reflected by the recording paper PP to reach the liquid ejection unit 3.

### D.2. Modified Example 2

In the first embodiment to the third embodiment and Modified Example 1 described above, the description is presented exemplifying the aspect in which the inkjet printer 1 is provided with the single ultraviolet irradiation unit 5 at the Y2 direction side with reference to the liquid ejection unit 3, but the present disclosure is not limited to such an aspect. The inkjet printer may be provided with a total of two ultraviolet irradiation units 5, that is, one ultraviolet irradiation unit 5 at the Y2 direction side with reference to the liquid ejection unit 3, and one ultraviolet irradiation unit 5 at the Y1 direction side with reference to the liquid ejection unit 3. In this case, the inkjet printer 1 ejects the ink from the liquid ejection unit 3 onto the recording paper PP and applies the ultraviolet light to the recording paper PP from the ultraviolet irradiation unit 5 disposed at the Y2 direction side with reference to the liquid ejection unit 3 while moving the carriage 110 in the Y1 direction, and ejects the ink from the liquid ejection unit 3 onto the recording paper PP and applies the ultraviolet light to the recording paper PP from the ultraviolet irradiation unit 5 disposed at the Y1 direction side with reference to the liquid ejection unit 3 while moving the carriage 110 in the Y2 direction to thereby execute the print processing.

### D.3. Modified Example 3

In the first to third embodiments and Modified Examples 1 and 2 described above, it is assumed that the inkjet printer 1 includes the four liquid ejection units 3, but the present disclosure is not limited to such an aspect. The inkjet printer 1 may be an apparatus including one or more and three or less liquid ejection units 3, or an apparatus including five or more liquid ejection units 3.

### E. Appendices

Some aspects which are understood from the above description will be described below. In order to facilitate understanding of the aspects, reference numerals in the drawings are added in parentheses for the sake of convenience in the following description, but it is not intended to limit the present disclosure to the illustrated aspects.

### E.1. Appendix 1

The inkjet printer 1 according to Appendix 1 will hereinafter be described.

### Appendix 1-1

The inkjet printer 1 according to Appendix 1-1 includes the liquid ejection unit 3 configured to eject the ink that is cured by irradiation with the ultraviolet light onto the recording paper PP, the ultraviolet irradiation unit 5 configured to irradiate the ink ejected onto the recording paper PP with the ultraviolet light, the carriage 110 that is loaded with the liquid ejection unit 3 and the ultraviolet irradiation unit 5 and is configured to move above the recording paper PP, and the carriage conveyance motor 91 configured to move the carriage 110, wherein the ultraviolet irradiation unit 5 includes the substrate 51 and the ultraviolet light source E that is disposed on the substrate 51 and is configured to emit the ultraviolet light, and the substrate 51 includes the base member 511 made of aluminum.

According to Appendix 1-1, since the substrate 51 having the base member 511 made of aluminum is adopted in the ultraviolet irradiation unit 5, it is possible to reduce the weight of the ultraviolet irradiation unit 5 compared to the aspect in which the substrate having the base material made of copper is adopted in the ultraviolet irradiation unit. Therefore, according to Appendix 1-1, it becomes possible to reduce the load applied to the carriage conveyance motor 91 for moving the carriage 110 loaded with the ultraviolet irradiation unit 5, to thereby increase the life of the carriage conveyance motor 91, and reduce the amount of electric power for driving the carriage conveyance motor 91.

### Appendix 1-2

The inkjet printer 1 according to Appendix 1-2 is the inkjet printer 1 according to Appendix 1-1, wherein at least a part of the heat generated in the ultraviolet light source E is released via the base member 511.

### Appendix 1-3

The inkjet printer 1 according to Appendix 1-3 is the inkjet printer 1 according to Appendix 1-1 or Appendix 1-2, wherein the surface area of the substrate 51 is larger than the area of the region where the ultraviolet light source E is disposed in the substrate 51.

According to Appendix 1-3, compared to the aspect in which the surface area of the substrate 51 is smaller than the area of the region where the ultraviolet light source E is disposed, it is possible to efficiently release the heat generated in the ultraviolet light source E.

### Appendix 1-4

The inkjet printer 1 according to Appendix 1-4 is the inkjet printer 1 according to one of Appendix 1-1 to Appendix 1-3, wherein the heatsink 52 made of aluminum is attached to the base member 511.

According to Appendix 1-4, since the heatsink 52 made of aluminum is attached to the base member 511 made of aluminum, it is possible to reduce the possibility that the corrosion occurs on the boundary between the base member 511 and the heatsink 52 compared to the aspect in which the heatsink 52 made of aluminum is attached to the base material made of copper. Therefore, according to Appendix 1-4, it is not necessary to interpose the heat dissipation sheet between the base member 511 and the heatsink 52, and it becomes possible to reduce the size of the ultraviolet irradiation unit 5, reduce the number of components of the ultraviolet irradiation unit 5, and improve the degree of freedom in designing the ultraviolet irradiation unit 5.

### Appendix 1-5

The inkjet printer 1 according to Appendix 1-5 is the inkjet printer 1 according to any one of Appendix 1-1 to Appendix 1-4, wherein the ultraviolet light source E is a light emitting diode (UV-LED) that emits the ultraviolet light.

According to Appendix 1-5, since the light emitting diode is adopted as the ultraviolet light source E, compared to an aspect in which a related-art light source such as a high pressure mercury lamp or a xenon lamp is adopted as the ultraviolet light source E, the heat generation amount is small and the size is small, which is suitable for mounting on the carriage 110.

### Appendix 1-6

The inkjet printer 1 according to Appendix 1-6 is the inkjet printer 1 according to one of Appendix 1-1 to

Appendix 1-5, wherein the substrate 51 is provided with the semiconductor temperature sensor 71.

According to Appendix 1-6, it becomes possible to figure out the temperature of the ultraviolet irradiation unit 5, and it is possible to determine whether to stop the ultraviolet light source E or to adjust the emission intensity of the ultraviolet light source E based on the temperature of the ultraviolet irradiation unit 5.

### Appendix 1-7

The inkjet printer 1 according to Appendix 1-7 is the inkjet printer 1 according to one of Appendix 1-1 to Appendix 1-6, wherein the substrate 51 is provided with the signal conversion circuit 72 for converting the output from the semiconductor temperature sensor 71 into a digital signal, and the semiconductor temperature sensor 71 and the signal conversion circuit 72 are packaged as a temperature detecting integrated circuit 7 which is an integrated circuit.

According to Appendix 1-7, compared to an aspect in which the output from the temperature detecting integrated circuit 7 is an analog signal, it is possible to reduce the possibility that noise is superimposed on the output signal from the temperature detecting integrated circuit 7.

### Appendix 1-8

The inkjet printer 1 according to Appendix 1-8 is the inkjet printer 1 according to any one of Appendix 1-1 to Appendix 1-7, wherein the ultraviolet irradiation unit 5 includes the housing 50 including the cover plate 502 that transmits the ultraviolet light and the frame 501, and the substrate 51 and the ultraviolet light source E are disposed in the housing 50.

### E.2. Appendix 2

The inkjet printer 1 according to Appendix 2 will hereinafter be described.

### Appendix 2-1

The inkjet printer 1 according to Appendix 2-1 includes the liquid ejection unit 3 configured to eject the ink that is cured by irradiation with the ultraviolet light onto the recording paper PP, the ultraviolet irradiation unit 5 configured to irradiate the ink ejected onto the recording paper PP with the ultraviolet light, the carriage 110 that is loaded with the liquid ejection unit 3 and the ultraviolet irradiation unit 5 and is configured to move above the recording paper PP, and the carriage conveyance motor 91 configured to move the carriage 110, wherein the ultraviolet irradiation unit 5 includes the substrate 51, the ultraviolet light source E which is disposed on the substrate 51, which has the radiant flux characteristic changing with temperature, and which is configured to emit the ultraviolet light, and the temperature detecting integrated circuit 7 which is the integrated circuit configured to detect the temperature in the ultraviolet irradiation unit 5 to output the temperature detection signal DT as a digital signal based on the temperature detected.

According to Appendix 2-1, since the temperature detecting integrated circuit 7 detects the temperature in the ultraviolet irradiation unit 5, it becomes possible to determine whether to stop the ultraviolet light source E or to adjust the emission intensity of the ultraviolet light source E based on the temperature in the ultraviolet irradiation unit 5 thus detected. Further, according to Appendix 2-1, since the temperature detecting integrated circuit 7 outputs the temperature detection signal DT which is a digital signal, it becomes possible to reduce the possibility that noise is superimposed on the temperature detection signal DT output from the temperature detecting integrated circuit 7, compared to an aspect in which the output from the temperature detecting integrated circuit 7 is an analog signal.

### Appendix 2-2

The inkjet printer 1 according to Appendix 2-2 is the inkjet printer 1 according to Appendix 2-1, wherein the radiant flux RE1 of the ultraviolet light emitted from the ultraviolet light source E at the temperature TE1 is more than the radiant flux RE2 of the ultraviolet light emitted from the ultraviolet light source E at the temperature TE2 higher than the temperature TE1.

### Appendix 2-3

The inkjet printer 1 according to Appendix 2-3 is the inkjet printer 1 according to Appendix 2-1 or Appendix 2-2, wherein the temperature detecting integrated circuit 7 includes the semiconductor temperature sensor 71 that detects the temperature and outputs the sensor output signal VT as an analog signal representing the detection result, and the signal conversion circuit 72 that converts the sensor output signal VT output from the semiconductor temperature sensor 71 into the temperature detection signal DT as a digital signal.

According to Appendix 2-3, since the temperature detecting integrated circuit 7 outputs the temperature detection signal DT which is a digital signal, it becomes possible to reduce the possibility that noise is superimposed on the temperature detection signal DT output from the temperature detecting integrated circuit 7, compared to an aspect in which the output from the temperature detecting integrated circuit 7 is an analog signal.

### Appendix 2-4

The inkjet printer 1 according to Appendix 2-4 is the inkjet printer 1 according to any one of Appendix 2-1 to Appendix 2-3, further including the control unit 2 configured to control the emission of the ultraviolet light in the ultraviolet light source E based on the temperature detection signal DT as the digital signal output from the temperature detecting integrated circuit 7.

According to Appendix 2-4, since the emission of the ultraviolet light from the ultraviolet light source E is controlled based on the temperature in the ultraviolet irradiation unit 5, it is possible to irradiate the ink on the recording paper PP with the ultraviolet light having an appropriate intensity, and it is possible to improve the printing quality of the inkjet printer 1 compared to an aspect in which the intensity of the ultraviolet light is not adjusted. In addition, according to Appendix 2-4, it becomes possible to prevent the emission of the ultraviolet light from the ultraviolet light source E with an inappropriate intensity, and it is possible to suppress a decrease in the printing quality of the inkjet printer 1 due to the irradiation of the recording paper PP with the ultraviolet light with an inappropriate intensity.

### Appendix 2-5

The inkjet printer 1 according to Appendix 2-5 is the inkjet printer 1 according to any one of Appendix 2-1 to Appendix 2-4, wherein the ultraviolet light source E includes the light emitting part 81 that emits the ultraviolet light and the lens part 82 that seals the light emitting part 81, and the water-repellent treatment is applied to the lens part 82.

According to Appendix 2-5, it is possible to prevent the illuminance of the ultraviolet irradiation unit 5 from being lowered due to adhesion of the ink to the lens part 82.

### Appendix 2-6

The inkjet printer 1 according to Appendix 2-6 is the inkjet printer 1 according to any one of Appendix 2-1 to Appendix 2-5, wherein the ultraviolet light source E includes the light emitting part 81 that emits the ultraviolet light and the lens part 82 that seals the light emitting part 81, and the lens part 82 is formed of silicone.

According to Appendix 2-6, since the silicone has the water-repellent property, it is possible to prevent the illuminance of the ultraviolet irradiation unit 5 from being lowered due to the adhesion of the ink to the lens part 82.

### Appendix 2-7

The inkjet printer 1 according to Appendix 2-7 is the inkjet printer 1 according to any one of Appendix 2-1 to Appendix 2-5, wherein the ultraviolet light source E includes the light emitting part 81 that emits the ultraviolet light and the lens part 82 that seals the light emitting part 81, the lens part 82 is formed of resin, and the ultraviolet irradiation unit 5 includes the cover plate 502 disposed between the ultraviolet light source E and the recording paper and PP, configured to transmit the ultraviolet light.

According to appendix 2-7, since the cover plate 502 prevents the ink from adhering to the ultraviolet light source E, it is possible to suppress the decrease of the illuminance of the ultraviolet irradiation unit 5 due to the adhesion of the ink to the lens part 82.

### Appendix 2-8

The inkjet printer 1 according to Appendix 2-8 is the inkjet printer 1 according to any one of Appendix 2-1 to Appendix 2-7, wherein the ultraviolet irradiation unit 5 includes the housing 50 configured to house the substrate 51, the ultraviolet light source E, and the temperature detecting integrated circuit 7.

### Appendix 2-9

The inkjet printer 1 according to Appendix 2-9 is the inkjet printer 1 according to any one of Appendix 2-1 to Appendix 2-8, wherein the gold plating 54 is applied to the wiring line 514 configured to electrically couple the ultraviolet light source E to the substrate 51.

According to Appendix 2-9, it is possible to lower the resistance of the wiring line 514 by the gold plating 54, and it is possible to stabilize the intensity of the ultraviolet light emitted from the ultraviolet light source E based on stable power supply to the ultraviolet light source E.

### Appendix 2-10

The inkjet printer 1 according to Appendix 2-10 is the inkjet printer 1 according to any one of Appendix 2-1 to Appendix 2-9, wherein the ultraviolet light source E includes the light emitting part 81 that emits the ultraviolet light, the lens part 82 that seals the light emitting part 81, and the package part 83 that protects the light emitting part 81, and the package part 83 is formed of ceramic.

According to Appendix 2-10, since the package part 83 made of ceramic is adopted, it is possible to suppress the deterioration of the package part 83 due to ozone generated by the reaction of the ultraviolet light with oxygen in the air, compared to an aspect in which the package part 83 is formed of resin.

### E.3. Appendix 3

The inkjet printer 1 according to Appendix 3 will hereinafter be described.

### Appendix 3-1

The inkjet printer 1 according to Appendix 3-1 includes the liquid ejection unit 3 configured to eject the ink that is cured by irradiation with the ultraviolet light onto the recording paper PP, the ultraviolet irradiation unit 5C configured to irradiate the ink ejected onto the recording paper PP with the ultraviolet light, the carriage 110 that is loaded with the liquid ejection unit 3 and the ultraviolet irradiation unit 5C so as to be arranged side by side in the Y1 direction and is configured to move above the recording paper PP in the Y1 direction, and the carriage conveyance motor 91 configured to move the carriage 110, wherein the ultraviolet irradiation unit 5C includes the ultraviolet light source E configured to emit the ultraviolet light, the wall surface 601B located between the ultraviolet light source E and the liquid ejection unit 3, the wall surface 602 located at the opposite side to the wall surface 601B across the ultraviolet light source E, and the light absorptance of the wall surface 602 is higher than the light absorptance of the wall surface 601B.

Note that, in Appendix 3, the wall surface 601B is an example of a “first wall surface”, the wall surface 602 is an example of a “second wall surface”, and the Y1 direction is an example of a “first direction”.

According to Appendix 3-1, since the light absorptance of the wall surface 602 is higher than the light absorptance of the wall surface 601B, it is possible to suppress the illuminance of the ultraviolet light reaching the liquid ejection unit 3 to be low compared to an aspect in which the light absorptance of the wall surface 602 is lower than the light absorptance of the wall surface 601B. Therefore, according to Appendix 3-1, it is possible to suppress the ink from being cured in the liquid ejection unit 3 and to reduce the occurrence of the ejection abnormality of the ink in the liquid ejection unit 3.

### Appendix 3-2

The inkjet printer 1 according to Appendix 3-2 is the inkjet printer 1 according to Appendix 3-1, wherein the wall surface 601B is a mirror surface, and the wall surface 602 is not a mirror surface.

According to Appendix 3-2, compared to an aspect in which the wall surface 602 is a mirror surface, it is possible to keep the illuminance of the ultraviolet light reaching the liquid ejection unit 3 low.

### Appendix 3-3

The inkjet printer 1 according to Appendix 3-3 is the inkjet printer 1 according to Appendix 3-1 or Appendix 3-2, wherein the ultraviolet light source E includes the light emitting part 81 that emits the ultraviolet light and the lens part 82 that seals the light emitting part 81, and the height of the lens part 82 is larger than the diameter of the lens part 82.

According to Appendix 3-3, compared to an aspect in which the height of the lens part 82 is equal to or smaller than the diameter of the lens part 82, it is possible to increase the directivity of the ultraviolet light emitted from the ultraviolet light source E. Therefore, according to Appendix 3-3, it is possible to suppress the illuminance of the ultraviolet light reaching the liquid ejection unit 3 to a low level.

### Appendix 3-4

The inkjet printer 1 according to Appendix 3-4 is the inkjet printer 1 according to any one of Appendix 3-1 to Appendix 3-3, wherein the liquid ejection unit 3 ejects the ink in the Z1 direction crossing the Y1 direction, and the wall surface 601B is disposed so that the distance dY1 in the Y1 direction between the wall surface 601B and the liquid ejection unit 3 when the distance in the Z1 direction from the substrate 51 provided with the ultraviolet light source E is the distance dZ1 becomes longer than the distance dY2 in the Y1 direction between the wall surface 601B and the liquid ejection unit 3 when the distance in the Z1 direction from the substrate 51 is the distance dZ2 longer than the distance dZ1.

In addition, in Appendix 3, the distance dZ1 is an example of a “first distance”, the distance dZ2 is an example of a “second distance”, and the Z1 direction is an example of a “second direction”.

According to Appendix 3-4, since the wall surface 601B is disposed so as to extend in the Y1 direction as the wall surface 601B extends in the Z1 direction, it is possible to increase the amount of the ultraviolet light emitted from the ultraviolet irradiation unit 5C to the recording paper PP compared to an aspect in which the wall surface 601B is disposed so as not to spread in the Y1 direction.

### Appendix 3-5

The inkjet printer 1 according to Appendix 3-5 is the inkjet printer 1 according to any one of Appendix 3-1 to Appendix 3-4, wherein the angle between the extension direction of the wall surface 601B and the Z1 direction is no smaller than 0 degree and no larger than 30 degrees in a cross-sectional view of ultraviolet irradiation unit 5C viewed in a direction perpendicular to the Y1 direction and the Z1 direction. That is, in the inkjet printer 1 according to Appendix 3-5 is the inkjet printer 1 according to any one of Appendix 3-1 to Appendix 3-4, wherein the angle between the normal direction of the wall surface 601B and the Z1 direction is no smaller than 60 degrees and no larger than 90 degrees.

According to Appendix 3-5, it is possible to increase the amount of the ultraviolet light emitted from the ultraviolet irradiation unit 5C to the recording paper PP compared to when the angle between the extension direction of the wall surface 601B and the Z1 direction is less than 0 degree or greater than 30 degrees.

### Appendix 3-6

The inkjet printer 1 according to Appendix 3-6 is the inkjet printer 1 according to any one of Appendix 3-1 to Appendix 3-5, wherein the ultraviolet irradiation unit 5C includes the cover plate 502 that is disposed between the ultraviolet light source E and the recording paper PP and is configured to transmit the ultraviolet light.

According to appendix 3-6, since the cover plate 502 prevents the ink from adhering to the ultraviolet light source E, it is possible to suppress the decrease in the illuminance of the ultraviolet irradiation unit 5C due to the adhesion of the ink to the lens part 82.

### Appendix 3-7

The inkjet printer 1 according to Appendix 3-7 is the inkjet printer 1 according to Appendix 3-6, wherein the cover plate 502 is replaceable without detaching the ultraviolet light source E from the ultraviolet irradiation unit 5C.

According to Appendix 3-7, when, for example, the ink adheres to the cover plate 502 and the ink is cured, only the cover plate 502 can be replaced without detaching the ultraviolet irradiation unit 5C, and therefore, the maintainability of the ultraviolet irradiation unit 5C is improved compared to an aspect in which the cover plate 502 is not replaceable.

### E.4. Appendix 4

The inkjet printer 1 according to Appendix 4 will hereinafter be described.

### Appendix 4-1

The inkjet printer 1 according to Appendix 4-1 includes the liquid ejection unit 3 configured to eject the ink that is cured by irradiation with the ultraviolet light onto the recording paper PP, the ultraviolet irradiation unit 5B configured to irradiate the ink ejected onto the recording paper PP with the ultraviolet light, the carriage 110 that is loaded with the liquid ejection unit 3 and the ultraviolet irradiation unit 5B so as to be arranged side by side in the Y1 direction and is configured to move above the recording paper PP in the Y1 direction; and the carriage conveyance motor 91 configured to move the carriage 110, wherein the distance between the ultraviolet irradiation unit 5B and the recording paper PP is no smaller than 1 mm and no larger than 15 mm, the ultraviolet irradiation unit 5B includes the ultraviolet light source E configured to emit the ultraviolet light toward the Z1 direction crossing the Y1 direction, and the wall surface 601B configured to reflect at least a part of the ultraviolet light emitted from the ultraviolet light source E, the angle between the extension direction of the wall surface 601B and the Z1 direction is no smaller than 5 degrees and no larger than 15 degrees in the cross-sectional view of the ultraviolet irradiation unit 5B viewed in the direction perpendicular to the Y1 direction and the Z1 direction.

In addition, in Appendix 4, the wall surface 601B is an example of a “reflective surface”, the Y1 direction is an example of a “first direction”, and the Z1 direction is an example of a “second direction”.

According to Appendix 4-1, since the angle between the extension direction of the wall surface 601B and the Z1 direction is no smaller than 5 degrees and no larger than 15 degrees, it is possible to increase the irradiation efficiency of the ultraviolet light from the ultraviolet irradiation unit 5B to the recording paper PP compared to when the angle between the extension direction of the wall surface 601B and the Z1 direction is smaller than 5 degrees. In addition, according to Appendix 4-1, since the angle between the extension direction of the wall surface 601B and the Z1 direction is no smaller than 5 degrees and no larger than 15 degrees, the maximum illuminance of the ultraviolet light from the ultraviolet irradiation unit 5B to the recording paper PP can be increased compared to when the angle between the extension direction of the wall surface 601B and the Z1 direction is larger than 15 degrees. That is, according to Appendix 4-1, it becomes possible to achieve both the increase in the maximum illuminance of the ultraviolet light from the ultraviolet irradiation unit 5B to the recording paper PP and the increase in the irradiation efficiency of the ultraviolet light from the ultraviolet irradiation unit 5B to the recording paper PP.

### Appendix 4-2

The inkjet printer 1 according to Appendix 4-2 is the inkjet printer 1 according Appendix 4-1, wherein the angle between the extension direction of the wall surface 601B and the Z1 direction is no smaller than 5 degrees and no larger than 10 degrees in the cross-sectional view of ultraviolet irradiation unit 5B viewed in a direction perpendicular to the Y1 direction and the Z1 direction.

That is, according to Appendix 4-2, it becomes possible to achieve both the increase in the maximum illuminance of the ultraviolet light from the ultraviolet irradiation unit 5B to the recording paper PP and the increase in the irradiation efficiency of the ultraviolet light from the ultraviolet irradiation unit 5B to the recording paper PP.

### Appendix 4-3

The inkjet printer 1 according to Appendix 4-3 is the inkjet printer 1 according to Appendix 4-1 or Appendix 4-2, wherein the ultraviolet light source E includes the light emitting part 81 that emits the ultraviolet light and the lens part 82 that seals the light emitting part 81, and the height of the lens part 82 is larger than the diameter of the lens part 82.

According to Appendix 4-3, compared to an aspect in which the height of the lens part 82 is equal to or smaller than the diameter of the lens part 82, it is possible to increase the directivity of the ultraviolet light emitted from the ultraviolet light source E.

### Appendix 4-4

The inkjet printer 1 according to Appendix 4-4 is the inkjet printer 1 according to any one of Appendix 4-1 to Appendix 4-3, further including a component made of rubber, wherein the wavelength of the ultraviolet light emitted from the ultraviolet light source E is 250 nm or more and 410 nm or less.

Note that, in Appendix 4, the component made of rubber is an example of a “specific component”.

According to Appendix 4-4, it is possible to reduce the possibility that the ultraviolet light emitted from the ultraviolet light source E reacts with oxygen in the air to generate ozone, compared to an aspect in which the ultraviolet light having a wavelength 100 nm or more and 230 nm or less is emitted from the ultraviolet light source E. Therefore, according to Appendix 4-4, it is possible to suppress the deterioration of the component made of rubber.

### Appendix 4-5

The inkjet printer 1 according to Appendix 4-5 is the inkjet printer 1 according to any one of Appendix 4-1 to Appendix 4-4, wherein the ultraviolet irradiation unit 5B includes the cover plate 502 that is disposed between the ultraviolet light source E and the recording paper PP and is configured to transmit the ultraviolet light.

According to appendix 4-5, since the cover plate 502 prevents the ink from adhering to the ultraviolet light source E, it is possible to suppress the decrease in the illuminance of the ultraviolet irradiation unit 5B due to the adhesion of the ink to the ultraviolet light source E.

### Appendix 4-6

The inkjet printer 1 according to Appendix 4-6 is the inkjet printer 1 according to Appendix 4-5, wherein the cover plate 502 is replaceable without detaching the ultraviolet light source E from the ultraviolet irradiation unit 5B.

According to Appendix 4-6, since only the cover plate 502 can be replaced without detaching the ultraviolet irradiation unit 5B, the maintainability of the ultraviolet irradiation unit 5B is improved compared to an aspect in which the cover plate 502 is not replaceable.

### E.5. Appendix 5

The inkjet printer 1 according to Appendix 5 will hereinafter be described.

### Appendix 5-1

The inkjet printer 1 according to Appendix 5-1 includes the liquid ejection unit 3 configured to eject the ink that is cured by irradiation with the ultraviolet light onto the recording paper PP, the ultraviolet irradiation unit 5B configured to irradiate the ink ejected onto the recording paper PP with the ultraviolet light, the carriage 110 that is loaded with the liquid ejection unit 3 and the ultraviolet irradiation unit 5 so as to be arranged side by side in the Y1 direction and is configured to move above the recording paper PP in the Y1 direction, and the carriage conveyance motor 91 configured to move the carriage 110, wherein the ultraviolet irradiation unit 5 includes the plurality of ultraviolet light sources E configured to emit the ultraviolet light toward the Z1 direction crossing the Y1 direction, one of the plurality of ultraviolet light sources E includes the light emitting part 81 configured to emit the ultraviolet light, and the lens part 82 configured to seal the light emitting part 81, the lens part 82 includes the base portion 821 having a columnar shape, and the tip portion 822 that has a hemispherical shape and is coupled at the Z1 direction side to the base portion 821, and the height dEZ in the Z1 direction of the lens part 82 is longer than the width dEY as the diameter of the base portion 821.

Note that, in Appendix 5, one of the ultraviolet light sources E is an example of a “first ultraviolet light source”, the Y1 direction is an example of a “first direction”, and the Z1 direction is an example of a “second direction”.

According to Appendix 5-1, compared to an aspect in which the height dEZ in the Z1 direction of the lens part 82 is equal to or smaller than the diameter of the base portion 821, it is possible to increase the directivity of the ultraviolet light emitted from the one of the ultraviolet light sources E. Therefore, according to Appendix 5-1, it is possible to improve the irradiation efficiency of the ultraviolet light from the ultraviolet irradiation unit 5, and to reduce the possibility that the ultraviolet light emitted from the ultraviolet irradiation unit 5 is reflected by the recording paper PP and reaches the liquid ejection unit 3 compared to the aspect in which the height dEZ in the Z1 direction of the lens part 82 is equal to or less than the diameter of the base portion 821.

### Appendix 5-2

The inkjet printer 1 according to Appendix 5-2 is the inkjet printer 1 according to Appendix 5-1, wherein the plurality of ultraviolet light sources E is arranged side by side in the Y1 direction and the X1 direction crossing the Y1 direction and the Z1 direction, and the interval dLY between two ultraviolet light sources E adjacent to each other in the Y1 direction out of the plurality of ultraviolet light sources E is equal to or larger than the interval dLX between two ultraviolet light sources E adjacent to each other in the X1 direction out of the plurality of ultraviolet light sources E.

Note that, in Appendix 5, the X1 direction is an example of a “third direction”.

According to Appendix 5-2, since the interval dLX is equal to or smaller than the interval dLY, it is possible to reduce unevenness in illuminance of the ultraviolet light sources E in the X1 direction. Therefore, according to Appendix 5-2, even when the carriage 110 loaded with the ultraviolet irradiation unit 5 moves in the Y1 direction, it becomes possible to irradiate the recording paper PP from the ultraviolet irradiation unit 5 with the ultraviolet light with a uniform intensity.

### Appendix 5-3

The inkjet printer 1 according to Appendix 5-3 is the inkjet printer 1 according to Appendix 5-1 or Appendix 5-2, wherein one of the plurality of ultraviolet light sources E is adjacent to another of the plurality of ultraviolet light sources E in the X1 direction, and the irradiation range on the recording paper PP with the ultraviolet light emitted from the one of the plurality of ultraviolet light sources E and the irradiation range on the recording paper PP with the ultraviolet light emitted from the other of the plurality of ultraviolet light sources E overlap each other.

Note that, in Appendix 5, the other of the plurality of ultraviolet light sources E is an example of a “second ultraviolet light source”.

According to Appendix 5-3, since the irradiation ranges with the ultraviolet light on the recording paper PP of the one of the ultraviolet light sources E and the other of the ultraviolet light sources E overlap each other, it becomes possible to reduce the unevenness in the illuminance of the ultraviolet light sources E in the X1 direction.

### Appendix 5-4

The inkjet printer 1 according to Appendix 5-4 is the inkjet printer 1 according to any one of Appendix 5-1 to Appendix 5-3, further including a component made of rubber, wherein the wavelength of the ultraviolet light emitted from the ultraviolet light source E is 250 nm or more and 410 nm or less.

Note that, in Appendix 5, the component made of rubber is an example of a “specific component”.

According to Appendix 5-4, it is possible to reduce the possibility that the ultraviolet light emitted from the ultraviolet light source E reacts with oxygen in the air to generate ozone, compared to an aspect in which the ultraviolet light having a wavelength 100 nm or more and 230 nm or less is emitted from the ultraviolet light source E. Therefore, according to Appendix 5-4, it becomes possible to suppress the deterioration of the component made of rubber.

### Appendix 5-5

The inkjet printer 1 according to Appendix 5-5 is the inkjet printer 1 according to any one of Appendix 5-1 to Appendix 5-4, wherein the ultraviolet irradiation unit 5 includes the heatsink 52 for cooling the plurality of ultraviolet light sources E.

According to Appendix 5-5, since the ultraviolet irradiation unit 5 includes the heatsink 52, it becomes possible to increase the life of the plurality of ultraviolet light sources E compared to an aspect in which the ultraviolet irradiation unit 5 does not include the heatsink 52. Therefore, according to Appendix 5-5, it is possible to reduce the possibility of replacing all of the plurality of ultraviolet light sources E in order to prevent the irradiation intensity of the ultraviolet light from the ultraviolet irradiation unit 5 from deviating from the desired intensity due to the occurrence of a failure in some of the plurality of ultraviolet light sources E.

### Appendix 5-6

The inkjet printer 1 according to Appendix 5-6 is the inkjet printer 1 according to any one of Appendix 5-1 to Appendix 5-5, wherein the ultraviolet irradiation unit 5 includes the cover plate 502 that is disposed between the ultraviolet light sources E and the recording paper PP and is configured to transmit the ultraviolet light.

According to appendix 5-6, since the cover plate 502 can prevent the ink from adhering to the ultraviolet light sources E, it is possible to suppress the decrease in the illuminance of the ultraviolet irradiation unit 5 due to the adhesion of the ink to the ultraviolet light source E.

### Appendix 5-7

The inkjet printer 1 according to Appendix 5-7 is the inkjet printer 1 according to any one of Appendix 5-1 to Appendix 5-6, wherein the cover plate 502 is replaceable without detaching the ultraviolet light source E from the ultraviolet irradiation unit 5.

According to Appendix 5-7, since only the cover plate 502 can be replaced without detaching the ultraviolet irradiation unit 5, the maintainability of the ultraviolet irradiation unit 5 is improved compared to an aspect in which the cover plate 502 is not replaceable.

What is claimed is:

1. A liquid ejection apparatus comprising:
a liquid ejection unit configured to eject a liquid that is cured by irradiation with ultraviolet light onto a medium;
an irradiation unit configured to irradiate the liquid ejected onto the medium with ultraviolet light;
a carriage loaded with the liquid ejection unit and the irradiation unit so as to be arranged side by side in a first direction, and configured to move above the medium in the first direction; and
a motor configured to move the carriage, wherein
the irradiation unit includes
an ultraviolet light source configured to emit the ultraviolet light,
a first wall surface located between the ultraviolet light source and the liquid ejection unit, and
a second wall surface located at a position at an opposite side to the first wall surface across the ultraviolet light source, and
a light absorptance of the second wall surface is higher than a light absorptance of the first wall surface.

2. The liquid ejection apparatus according to claim 1, wherein
the first wall surface is a mirror surface, and
the second wall surface is not a mirror surface.

3. The liquid ejection apparatus according to claim 1, wherein
the ultraviolet light source includes a light emitting part configured to emit the ultraviolet light, and a lens part configured to seal the light emitting part, and
a height of the lens part is larger than a diameter of the lens part.

4. The liquid ejection apparatus according to claim 1, wherein
the liquid ejection unit is configured to eject the liquid toward a second direction crossing g the first direction, and
the first wall surface is disposed so that a distance in the first direction between the first wall surface and the liquid ejection unit when a distance in the second direction from the substrate provided with the ultraviolet light source is a first distance is longer than a distance in the first direction between the first wall surface and the liquid ejection unit when the distance in the second direction from the substrate is a second distance longer than the first distance.

5. The liquid ejection apparatus according to claim 4, wherein
an angle between an extending direction of the first wall surface and the second direction is no smaller than 0 degree and no larger than 30 degrees in a cross-sectional view of the irradiation unit viewed in a direction perpendicular to the first direction and the second direction.

6. The liquid ejection apparatus according to claim 1, wherein
the irradiation unit includes a cover plate disposed between the ultraviolet light source and the medium and configured to transmit the ultraviolet light.

7. The liquid ejection apparatus according to claim 6, wherein
the cover plate is replaceable without detaching the ultraviolet light source from the irradiation unit.

8. An ultraviolet irradiation apparatus provided to a liquid ejection apparatus including
a liquid ejection unit configured to eject a liquid that is cured by irradiation with ultraviolet light onto a medium,
a carriage loaded with the liquid ejection unit, and configured to move in a first direction above the medium, and
a motor configured to move the carriage, and
mounted on the carriage so as to be arranged side by side in the first direction with the liquid ejection unit to irradiate the liquid ejected on the medium with ultraviolet light, the ultraviolet irradiation apparatus comprising:
an ultraviolet light source configured to emit the ultraviolet light;
a first wall surface located between the ultraviolet light source and the liquid ejection unit; and
a second wall surface located at a position at an opposite side to the first wall surface across the ultraviolet light source, wherein
a light absorptance of the second wall surface is higher than a light absorptance of the first wall surface.

9. The ultraviolet irradiation apparatus according to claim 8, wherein
the first wall surface is a mirror surface, and
the second wall surface is not a mirror surface.

10. The ultraviolet irradiation apparatus according to claim 8, wherein
the ultraviolet light source includes a light emitting part configured to emit the ultraviolet light, and a lens part configured to seal the light emitting part, and
a height of the lens part is larger than a diameter of the lens part.

11. The ultraviolet irradiation apparatus according to claim 8, wherein
the liquid ejection unit is configured to eject the liquid toward a second direction crossing the first direction, and
the first wall surface is disposed so that a distance in the first direction between the first wall surface and the liquid ejection unit when a distance in the second direction from the substrate provided with the ultraviolet light source is a first distance is longer than a distance in the first direction between the first wall surface and the liquid ejection unit when the distance in the second direction from the substrate is a second distance longer than the first distance.

12. The ultraviolet irradiation apparatus according to claim 11, wherein
an angle between an extending direction of the first wall surface and the second direction is no smaller than 0 degree and no larger than 30 degrees in a cross-sectional view of the ultraviolet irradiation apparatus viewed in a direction perpendicular to the first direction and the second direction.

13. The ultraviolet irradiation apparatus according to claim 8, further comprising
a cover plate disposed between the ultraviolet light source and the medium and configured to transmit the ultraviolet light.

14. The ultraviolet irradiation apparatus according to claim 13, wherein
the cover plate is replaceable without detaching the ultraviolet light source from the ultraviolet irradiation apparatus.
